(19) United States
(12) Patent Application Publication
(10) Pub. No.: US 2015/0149238 A1
(43) Pub. Date: May 28, 2015

(54) JOB SITE MATERIAL TRACKING AND DISCREPANCY RECONCILIATION

(71) Applicant: TSN LLC, Atlanta, GA (US)

(72) Inventors: Robert Glustrom, Atlanta, GA (US); Richard Schafer, Sachse, TX (US)

(21) Appl. No.: 14/554,884

(22) Filed: Nov. 26, 2014

Related U.S. Application Data
(60) Provisional application No. 61/909,877, filed on Nov. 27, 2013.

(51) Int. Cl. G06Q 10/06; G06Q 10/08

(52) U.S. Cl. CPC G06Q 10/0633; G06Q 10/0833
USPC 705/7.27

(57) ABSTRACT

Utilities designed to track and report on numerous aspects of the movement of assets from an organization and/or customer's location to one or more job sites of a project and vice versa to allow the organization and/or customer(s) to monitor such asset movements. Broadly, the utilities employ a number of timing modules that are each configured to monitor for the occurrence of one or more events (e.g., organization acquires customer's assets, assets picked up from organization's warehouse by general contractor, assets checked into job site by general contractor, etc.) and collect or generate metrics related to the performance of the events. The disclosed utilities provide for increased visibility (e.g., transparency) into various types of performance metrics (e.g., in relation to accuracy, completeness, delays, etc.) related to the movement of the assets and thus allow organizations, their customers, and the like to more readily identify asset misplacement, mismanagement, etc.

### CROSS REFERENCE TO RELATED APPLICATIONS

This application claims priority to U.S. Ser. No. 61/909,877, entitled “JOB SITE MATERIAL TRACKING AND DISCREPANCY RECONCILIATION,” filed on Nov. 27, 2013, the entire contents of which are incorporated herein by reference as if set forth in full.

### BACKGROUND

1. Field of the Invention

The present invention generally relates to asset management and, more particularly to systems, methods and other utilities that facilitate movement of assets of an organization and/or its customers to one or more job sites that utilize the moved assets.

2. Relevant Background

Entities often hire or otherwise contract with one or more organizations to perform services, build products, or the like for the entities. As an example, technology service providers (e.g., organizations) are asked by mobile service providers (e.g., their customers) to design, construct and/or upgrade wireless networks for the mobile service providers. In this pursuit, assets (e.g., materials, parts, etc., such as antennas, switches, etc.) of both the organization and the customer are often used to construct the network at a plurality of job sites.

One concern that often arises is the tracking and accountability of assets during the “last mile” before the assets reach a particular job site at which the assets will be incorporated into one or more fixed structures or designs. More specifically, assets often change hands, transportations paths, etc. multiple times from the time the customer instructs the organization to pick up its assets that it is contributing to the project (e.g., via a “material callout”) to the time the assets eventually reach the job site(s) and are ultimately implemented at the job site(s). For instance, the organization, general contractors, shipping and logistics companies, and the like all typically have their hands on the assets during the last mile before the assets reach the job sites. In this regard, the opportunities for assets to be misplaced, delayed deliveries, and the like all can become amplified.

### SUMMARY

Existing products are limited in their ability to accurately monitor (or do not even monitor in the first place) and facilitate timely movement of assets between a customer and/or technology service provider's (or other organization's) location (e.g., warehouses) and one or more job sites of a project being carried out for the customer by the technology service provider or other organization. As a result, numerous assets are often misplaced or otherwise mismanaged, organizations (e.g., the technology service provider in this example) and their customers are limited in their ability to identify the source(s) of such misplacement or mismanagement (e.g., general contractors, materials lists, etc.), and the like.

In this regard, disclosed herein are systems and processes (e.g., “utilities”) for tracking, monitoring and facilitating the movement of assets from a customer's or an organization's location (e.g., warehouse, etc.) to one or more job sites where the assets are to be installed or otherwise utilized (e.g., the “last mile” before the assets reach the job sites) in a manner that provides for increased visibility (e.g., transparency) into various types of performance metrics (e.g., in relation to accuracy, completeness, delays, etc.) related to the movement of the assets. Broadly, the utilities employ a number of timing or timer modules that are each configured to monitor whether or not (or the degree to which) one or more “events” (e.g., organization acquires customer's assets, assets picked up from organization's warehouse by general contractor, assets checked into job site by general contractor, etc.) have occurred in a previously-determined but configurable amount of time (e.g., where the timers of some timing modules may be longer or shorter than those of other timing modules).

In one embodiment, some of the timing modules may be dependent on other timing modules such that one timing module may not commence the monitoring of one or more events until a previous timing module has completed its monitoring of one or more events. Additionally or alternatively, some of the timing modules may implement their monitoring of one or more events under the purview of one or more other timing modules. A collection engine may be configured to collect any appropriate data and/or metrics from the various timing modules (e.g., how long a respective timer ran before a corresponding event occurred, expired timer alerts, etc.) as well as from messages and uploaded data received from various players involved with moving the assets to the job site (e.g., project managers, asset warehouses, general contractors, etc.), determine and/or generate (e.g., in real time, according to a user-defined schedule, etc.) any configurable number of performance metrics or statistics based on the same (e.g., total number of expired timers, average time to deliver assets to job site, etc.), and store the same in any appropriate storage. The various metrics, statistics, and/or data may be presented to users in any appropriate manner (e.g., via a dashboard or the like) to allow the users to gauge the performance of those responsible for moving assets to job sites, determine the degree to which assets were implemented at the jobs sites, and/or the like.

In this regard, the present utilities serve to track and report on numerous aspects of the movement of assets from an organization and/or customer's location to one or more job sites to facilitate timely movement of the assets to the job site (e.g., facilitate movement of the assets to the job site within any user-defined period of time). As an example, the technology service provider in the above example may receive a message (e.g., a “material callout”) from their customer that the customer has assets ready to be picked up by the technology service provider for eventual delivery to one or more job sites. For instance, the utilities may record and store the message and any related data in the message (e.g., part numbers, quantities, project number, job site location, etc.) in any appropriate location (e.g., central server) and generate and send an alert or other message to the technology service provider that the technology service provider has a particular period of time (e.g., 24 hours or the like as configured in a timer of the timing module) to obtain the assets and check the same into a warehouse or the like of the technology service provider.

In conjunction (e.g., substantially simultaneously) with receipt of the message, the utilities may initiate or trigger a first timing module to monitor for the assets being received at the job site with a first period of time (e.g., 7 days). Also in conjunction with receipt of the message or at least the generation of the alert/message, the utilities may initiate or trigger a second timing module to monitor for the assets being checked into the warehouse (e.g., where checking the items into the warehouse is one stage or step of the overall process of moving the assets to the job site) within a second period of time (e.g., 24 hours) that is less than the first period of time. In the event the assets are not checked into the warehouse within the particular period of time, the second timing module may automatically generate an expired timer alert or message regarding the same which may be appropriately stored and sent to one or more appropriate parties for reconciliation of the expired timer (e.g., to investigate why the assets were not checked into the warehouse within the second period of time). Upon the assets being obtained and checked into the warehouse, the second timing module may record or determine data or metrics regarding the same (e.g., a timestamp of the above “event,” how long a timer of the second timing module ran until the event occurred, etc.) which may be collected for use in generating further metrics and presenting the same to users. Also upon the assets being checked into the warehouse, the utilities may generate and send further messages and notifications for additional parties to take actions ultimately relating to movement of the assets to the job site and initiate additional timer modules configured to monitor the same, where each additional timer module is configured to run for a period of time that is less than the first timer module (e.g., the overall timer module), and where at least some of the additional timer modules may not be initiated until previously initiated timer modules have been stopped. In this regard, the second and various additional timer modules may be considered “sub-timers” of the overall timer module that are configured to facilitate delivery of the assets to the job site before expiration of the overall timer module.

For instance, upon the assets being manually and/or automatically checked in at the warehouse of the technology service provider (e.g., upon a representative of the technology service provider at the warehouse clicking an “assets received” button or the like on a web-based interface in communication with the central server, scanning any appropriate barcode (e.g., two-dimensional, matrix, etc.), via RFID tags, etc.), any appropriate message may be sent to the central server indicating receipt of the assets. In the event the assets are not picked up from the customer and checked into the warehouse of the technology service provider within the time period of the timing module, the utilities may be configured, for instance, to initiate any appropriate “escalation” processes whereby managers, supervisors, etc. may be appropriately notified (e.g., via alerts, text messages, etc.) that an event has not occurred within the time period of a particular timing module (e.g., that a timer has expired). Furthermore, the timing module may be automatically configured to record and store any appropriate metrics indicative of the failure of the event to occur within the time period of the timing module.

As another example, assume a project manager or the like of the technology service provider generates a callout to the warehouse of the technology service provider specifying how the assets (e.g., those of the customer and/or of the technology service provider) are to be moved to the one or more job sites (e.g., shipper type such as via a general contractor and/or a division of the technology service provider itself). For instance, the utilities may record and store the callout and any related data in the message in the central server or other appropriate location and then initiate another timing module that monitors whether or not the warehouse has notified the shipper(s) that assets are ready for pickup within a particular period of time (e.g., where the timing module may similarly record or determine any appropriate data or performance metrics). Upon the shipper receiving notification that the assets are ready for pickup, another timing module may be implemented that sets forth a period of time within which the shipper is to either confirm the pickup or provide a reason for delay (e.g., where the reason for delay may be one of a fixed number of “acceptable” reasons for delay previously decided upon by the technology service provider and/or the customer). Upon the shipper picking up the assets, the utilities may initiate another timing module that sets forth another period of time within which the shipper is to deliver the assets to the one or more job sites.

In one aspect, a method for use in monitoring movement of assets towards at least one job site of a project is disclosed. The method includes generating, by a processor of a central server, a message that assets of a project are to be picked up from a location of an organization by a shipper; sending the generated message to the shipper; initiating, in conjunction with the sending, a first timer of a first timing module of the central server that sets forth a first period of time within which the shipper is to acknowledge receipt of the generated message; collecting, by the central server, metrics related to acknowledgement of the message by the shipper; and storing the collected metrics in a database of the central server.

In one arrangement, the method may include, before the generating by the first timing module: receiving, at the central server, a message that assets of the project are to be picked up from a location of a customer by the organization; generating, by the processor of the central server, an alert that the assets of the project are to be picked up from a location of the customer by the organization; sending the alert to the organization; initiating, in conjunction with the sending, a second timer of a second timing module of the central server that sets forth a second period of time within which the assets are to be picked up by the organization from the location of the customer; collecting, by the central server, metrics related to picking up of the assets by the organization from the location of the customer; and storing the collected metrics in the database of the central server.

For instance, confirmation that the assets of the project were picked up from the location of the organization by the shipper may be received at the central server and then the method may include, in conjunction with the receiving, initiating, a third timer of a third timing module of the central server that sets forth a third period of time within which the assets are to be received at least one job site of the project; collecting, by the central server, metrics related to receipt of the assets at the at least one job site; and storing the collected metrics in the database of the central server.

In another aspect, a method for use in monitoring movement of assets to at least one job site of a project is disclosed. The method includes receiving, at a central server, a message that assets of a project are to be picked up from a location of a customer by an organization for delivery to at least one job site of a project; initiating, by a processor of the central server in conjunction with the receiving, a timer of a timing module that sets forth a period of time within which the assets are to be delivered to the at least one job site of the project; generating, by the processor in conjunction with the initiating, an alert that the assets of the project are to be picked up from the location of the customer by the organization; sending, by the processor, the alert to the organization; obtaining metrics related to picking up of the assets by the organization from the location of the customer; and storing the obtained metrics in a database of the central server.

In one arrangement, the timing module is a first timing module, and the initiating further includes initiating, by the processor in conjunction with the generating, a timer of a second timing module that sets forth a period of time within which the assets are to be picked up by the organization from the location of the customer and received at a location of the organization, wherein the timer of the second timing module is configured to expire before the timer of the first timing module is configured to expire. For instance, the method may further include obtaining metrics related to the timer of at least one of the first and second timer modules; and storing the obtained metrics in the database of the server.

In one variation, the method may further include receiving, at the processor of the central server, a signal that the assets have been received at the location of the organization; generating, by the processor in response to the receiving, a message that the assets are to be picked up from the location of the organization by a shipper; sending the generated message to the shipper; initiating, in conjunction with the generating, a timer of a third timing module of the central server that sets forth a period of time within which the shipper is to acknowledge receipt of the generated message; collecting, by the central server, metrics related to acknowledgement of the message by the shipper; and storing the collected metrics in the database of the central server.

The disclosed utilities are also configured to track and report on the return of assets (e.g., unused assets, extra assets, incorrect assets, etc.) from the one or more job sites to the warehouse of the organization, the customer, and/or other locations. As an example, a project manager or the like may initiate a return material authorization process via a user interface in communication with the disclosed utilities whereby a communication (e.g., email, text message, etc.) regarding return of assets from the job sites may be automatically sent to one or more general contractors associated with a project. For instance, the communication may include a specific list of assets to be returned from the job site(s) for review and consideration by the general contractor. In one arrangement, the general contractor may be able to appropriately modify one or more fields in the list of assets being returned such as asset part numbers, total quantities, etc. For instance, the communication may include an attachment or the like with a list of all assets received at the job site for completion of the project. After completion of the project, the general contractor may appropriately update the assets total and/or other information in the list to reflect the assets to be returned from the job site (e.g., where the updated asset total is a subset of the original asset total).

In any case, the general contractor may then, after review and any appropriate modification of the return material communication from the project manager, confirm the receipt of the communication in any appropriate manner. As an example, the general contractor may confirm receipt by way of uploading the list of assets and any associated data (e.g., part numbers, quantities, etc.) to a central server configured to implement the disclosed utilities, whereby a project manager may access the central server to approve the uploaded list of assets. Upon upload of the list of assets by the general contractor to the central server, for instance, the project manager may be appropriately notified (e.g., email, text message, etc.) and triggered to confirm and approve the uploaded list of assets. The project manager may contact the general contractor to resolve any noted discrepancies.

Once the project manager has approved the upload, the utilities may automatically generate and send the list of assets to each of the one or more particular warehouses or other locations to which the general contractor(s) are to return the assets (e.g., via email or text message to one or more managers or other parties managing the warehouse(s)). The utilities may also send a communication to the general contractor(s) to return the assets indicated in the list of assets to the one or more particular warehouses within a particular period of time. The assets may be considered “returned” when the assets are checked in at the one or more warehouse(s). Each warehouse may use the automatically generated and received list of assets to check in the assets from the general contractor(s). The utilities may be configured to determine and/or record various data and metrics associated with each stage in the return of the assets from the job site to the warehouse and/or other location (e.g., timestamp of return material authorization, uploaded lists of assets to be returned, etc.). In one arrangement, timing modules may be implemented (e.g., in conjunction with sending of the asset return communication to the general contractor(s)) that serves to track and report on whether or not one or more of the stages occur within various respective particular periods of time.

In one arrangement, any appropriate automatic asset disposition tracking processes may be initiated upon assets leaving one location (e.g., the customer's location) to verify that all assets that left the location are actually received at another location (e.g., the technology service provider's location). In the event of any asset discrepancies, any appropriate reconciliation processes may be implemented. For instance, the asset disposition and reconciliation processes disclosed in U.S. Pat. No. 8,650,101, entitled “INTERNAL MATERIAL SYSTEM FOR FACILITATING MATERIAL AND ASSET MOVEMENT WITHIN ORGANIZATIONAL INFRASTRUCTURES,” assigned to the Assignee of the present application, filed on Oct. 3, 2011, and issued on Feb. 11, 2014 may be utilized; the entirety of this patent is incorporated herein by reference in relation to the asset disposition and reconciliation process as well as all other subject matter disclosed therein.

Any of the embodiments, arrangements, or the like discussed herein may be used (either alone or in combination with other embodiments, arrangement, or the like) with any of the disclosed aspects. Merely introducing a feature in accordance with commonly accepted antecedent basis practice does not limit the corresponding feature to the singular. Any failure to use phrases such as “at least one” does not limit the corresponding feature to the singular. Use of the phrase “at least generally,” “at least partially,” “substantially” or the like in relation to a particular feature encompasses the corresponding characteristic and insubstantial variations thereof. Furthermore, a reference of a feature in conjunction with the phrase “in one embodiment” does not limit the use of the feature to a single embodiment.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a schematic diagram of a system including a central server that is configured to monitor and report on various aspects of the movement of assets to a job site among an organization responsible for managing a project that includes the job site, one or more general contractors or construction managers responsible for incorporating the assets into the project at the job site, and one or more customers for whom the project is being carried out.

FIG. 2 is a more detailed schematic diagram of the central server of FIG. 1 and illustrating how the central server facilitates monitoring and reporting on various aspects of the movement of assets to a job site among a customer, a project manager of the organization, a warehouse of the organization, and a general contractor or construction manager tasked with delivering and incorporating assets into the job site.

FIG. 3 is a swim lane diagram of a method of tracking and monitoring materials called out by a customer for delivery to a job site according to an embodiment.

FIGS. 4-17 are various screenshots presentable to users by the central server of FIG. 2 in association with the method of FIG. 3.

FIG. 18 is a swim lane diagram of a method of tracking and monitoring materials called out by an organization for delivery to a job site according to an embodiment.

FIGS. 19-23 are various screenshots presentable to users by the central server of FIG. 2 in association with the method of FIG. 18.

FIG. 24 is a swim lane diagram of a method of tracking and monitoring materials to be returned to the organization by a general contractor or construction manager according to an embodiment.

FIGS. 25 and 26 are various screenshots presentable to users by the central server of FIG. 2 in association with the method of FIG. 24.

FIG. 27 is a swim lane diagram of a method of tracking and monitoring materials to be returned to the organization by a general contractor or construction manager according to an embodiment.

FIG. 28 is a screenshot presentable to users by the central server of FIG. 2 in association with the method of FIG. 27.

FIG. 29 is a screenshot presentable to users by the central server of FIG. 2 of a reporting dashboard that displays various metrics and analytics associated with the utilities disclosed herein.

### DETAILED DESCRIPTION

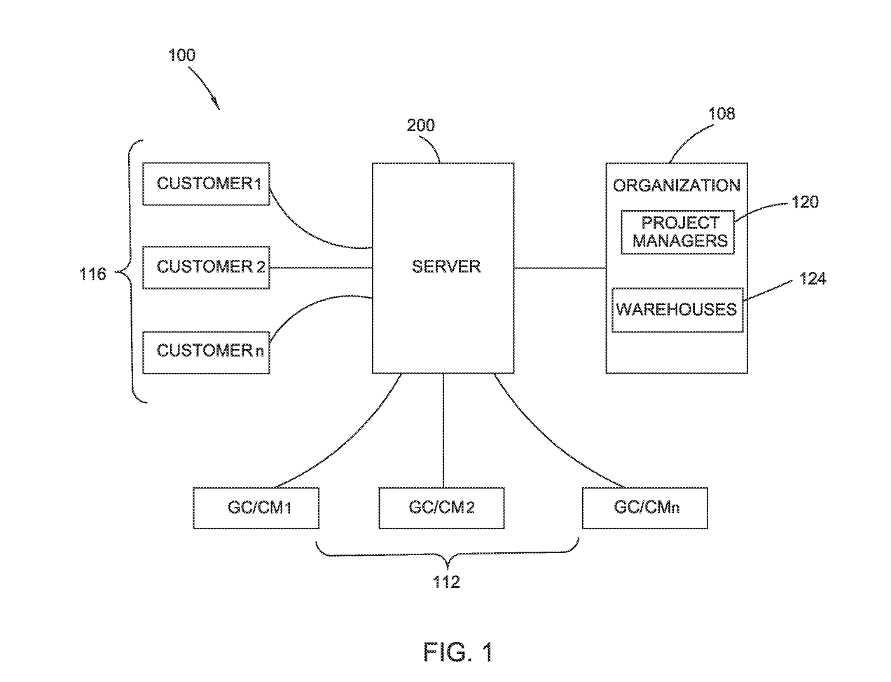

The present disclosure generally relates to utilities designed to track and report on numerous aspects of the movement of assets from an organization and/or customer's location to one or more job sites of a project and vice versa to allow the organization and/or customer(s) to monitor such asset movements. With reference to FIG. 1, a schematic diagram of a system 100 including a central server 200 that is configured to monitor and report on various aspects of the movement of assets to a job site among an organization 108 responsible for managing a project that includes the job site, one or more general contractors (GCs) or construction managers (CMs) 112 responsible for incorporating the assets into the project at the job site, and one or more customers 116 for whom the project is being carried out. For instance, the organization 108 may be a technology service provider hired by one or more customers 116 (e.g., wireless service providers) to build or upgrade a wireless network for the customers 116.

As shown, the organization 108 includes a plurality of project managers 120 for managing one or more projects of the organization 108 for the one or more customers 116, a plurality of warehouses 124 or other locations for receiving, storing and issuing assets (e.g., materials) associated with the one or more projects, and/or the like. While much of the following discussion will be in the context of service providers (i.e., entities that provide services such as subscription or web services to other entities, such as communications service providers, telecommunications services providers, etc.) as doing so is particularly useful manner of explaining the various functionalities of the disclosed utilities due to the extent of the large scale movement of numerous types of assets (e.g., parts necessary to build cellular towers, switching stations, etc.) involved in carrying out projects, it is to be understood that the disclosed utilities may also be utilized in various other contexts.

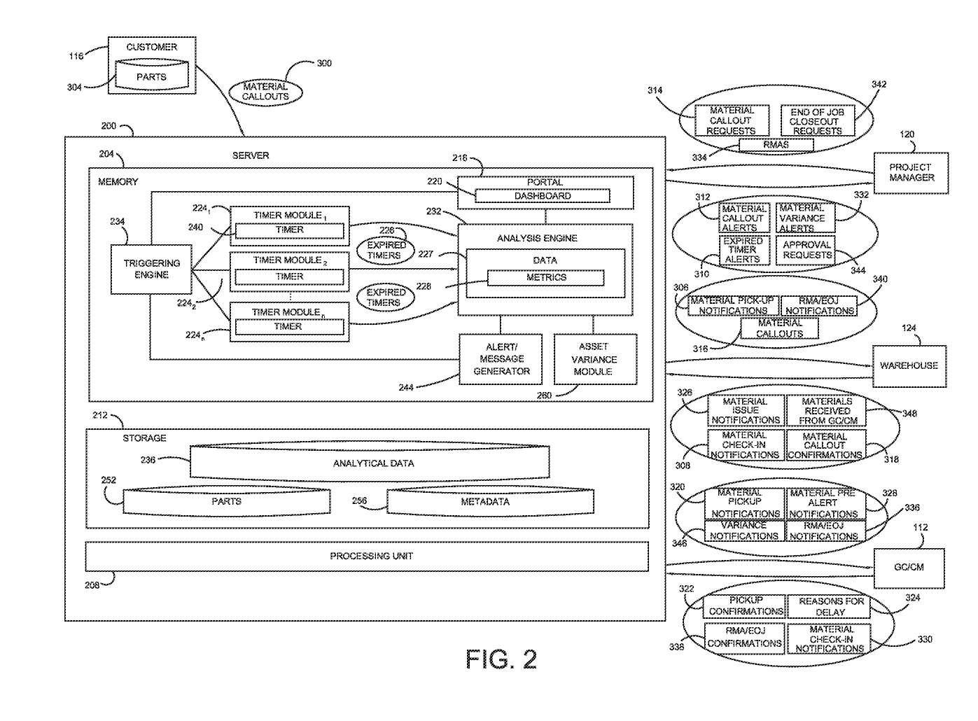

FIG. 2 is a more detailed schematic diagram of the central server 200 of FIG. 1 that illustrates how the server 200 facilitates monitoring and reporting on various aspects of the movement of assets to a job site among a customer 116, a project manager 120 of the organization 108, a warehouse 124 of the organization 108, and a GC/CM 112 tasked with delivering and incorporating assets into the job site. While only a single customer 116, project manager 120, warehouse 124 and GC/CM 112 have been shown in FIG. 2, the server may be configured to facilitate asset movement tracking and reporting among a plurality of customers 116, project managers 120, warehouses 124, GC/CMs 112, etc. Furthermore, although depicted as a single device (e.g., server, workstation, laptop, desktop, mobile device, and/or other computing device), one or more functionalities, processes or modules of the server 200 may be allocated or divided among a plurality of machines, devices and/or processes which may or may not be embodied in a single housing. In one arrangement, functionalities of the server 200 may be embodied in any appropriate cloud or distributed computing environment.

The server 200 may include memory 204 (e.g., one or more RAM or other volatile memory modules), a processing engine or unit 208 (e.g., one or more CPUs) for executing computer readable instructions from the memory 204, storage 212 (e.g., one or more magnetic disks, flash memory, or other non-volatile memory modules), and/or a number of other components (e.g., input devices such as a keyboard and mouse, output devices such as a display and speakers, and the like, not shown), all of which may be appropriately interconnected by a system bus (not shown). While not shown, the server 200 may include any appropriate number and arrangement of interfaces that facilitate interconnection between the system bus and the various components of the server 200 as well as with other devices or entities (e.g., project manager 120, warehouse 124, GC/CM 112, etc.).

As shown, the memory 204 may include a number of programs, modules, engines, etc. (for execution by the processing unit 208) that are configured to carry out the various utilities disclosed herein. For instance, the memory 204 may include a portal 216 (e.g., an Internet or web-based platform) through which users (e.g., administrators, project manager 120, warehouses 124, GC/CM 112, etc.) can generate material callouts, upload material lists, confirm receipt of materials ready for pickup, and the like as appropriate as will be discussed herein. For instance, any appropriate browser (not shown) running on client devices (e.g., including memory, processor, storage, display, etc.) of the project manager 120, warehouse 124, etc. may appropriately access the portal 216 via one or more networks (e.g., WAN, LAN, Internet, not shown), which may entail entering or providing any appropriate credentials such as user name and password. In some arrangements, the server 200 may be configured to generate and send automated messages (e.g., emails, text messages, etc.) to the users with embedded links that provide direct access to one or more (e.g., but not necessarily all) functionalities of the portal 216 (e.g., to allow users to upload documents, confirm receipt of materials ready for pickup, etc.). The portal 216 may also provide access to a reporting dashboard 220 that presents administrators and the like with various types of metrics and analytics related to the movement of assets to job sites as discussed in more detailed herein.

As shown in FIG. 2, the memory 204 of the server 200 also includes a plurality of timer modules 224 (e.g., timer module 224₁, 224₂, 224ₙ) that are broadly configured to monitor for the occurrence of various respective events associated with the movement of assets to the job site, generate expired timer signals 226 when the events fail to occur within a user-specified period of time, and generate or provide any appropriate data 227 based on occurrence of the events (e.g., timestamp of event occurrence, process ID number, etc.) to an analysis engine 232 of the server 200 that is configured to generate any appropriate metrics 228 based on the data 227. The data 227 and generated metrics 228 may be stored in storage 212 in any appropriate manner (e.g., as analytical data 236) for presentation to users via the dashboard 220 of the portal 216.

For instance, each timer module 224 may include a timer 240 of any appropriate configurable period of time (e.g., 8 hours, 24 hours, 72 hours, etc.) that is configured to start upon initiation of the timer module 224 and end upon occurrence of a corresponding event (e.g., upon receipt of a communication at the server 200 indicating occurrence of the event). The various timer modules 224 may appropriately manipulated (e.g., triggered, initiated, started, stopped, etc.) by a triggering engine 234 of the server 200 based at least in part on signals received from the portal 216. In conjunction with the triggering of one more of the timer modules 224, the triggering engine 234 may also trigger an alert/message generator 244 of the server 200 to generate and send one or more appropriate messages (e.g., emails, text messages, etc.) to one or more parties (e.g., representative of warehouse 124, GC/CM 112, etc.) associated with movement of the assets to the job site.

While the various timer modules 224, triggering engine 234, etc. have been depicted in FIG. 2 as being separate or distinct modules, it is to be understood that the functionalities or instructions of two or more of the timer modules 224 or the like may actually be integrated as part of the same computer-readable instruction set and that the timer modules 224 have been depicted in the manner shown in FIG. 2 merely to highlight various functionalities of the server 200. Furthermore, while the timer modules 224 and other modules (e.g., portal 216, triggering engine 234, analysis engine 232) have been illustrated as being resident within the (e.g., volatile) memory 204 (e.g., for execution by the processing unit 208), it is to be understood that the modules may be stored in (e.g., non-volatile) storage 212 (and/or other non-volatile storage in communication with the server 200) and loaded into the memory 204 as appropriate.

As a simplistic example, imagine the customer 116 generates and sends a material callout 300 (e.g., message such as an email, text message, etc.) to the organization 108 via the server 200 that particular parts 304 (e.g., assets) are to be picked up from the customer's location (e.g., a particular warehouse of the customer) and delivered to a particular job site of a project being carried out for the customer 116 by the organization 108. Upon receipt of the material callout at the server 200, the triggering engine 234 may trigger a first timer module 224₁ to initiate its timer 240 (e.g., an overall job timer) that sets forth a first particular period of time within which the particular materials are to be received at the job site. In conjunction (e.g., simultaneous) with initiation of the overall job timer 240 of the first timer module 224₁, the triggering engine 234 may also trigger a second timer module 224₂ to initiate its timer 240 setting forth a second particular period of time within which the customer's parts are to be picked up and checked into a warehouse 124 of the organization 108 (where the second period of time is less than the first period of time).

For instance, the triggering engine 234 may trigger the message generator 244 to generate and send a material pickup notification 306 (e.g., message, email, etc.) to the warehouse 124 (e.g., to any appropriate representative or user of the warehouse 124) that the parts are to be picked up from the customer's location at substantially the same time that the timer 240 of the second timer module 224₂ is initiated. Upon representatives of the warehouse 124 picking up (or arranging for pickup of) the customer parts 304 and confirming receipt of the same via sending a material check-in notification 308 (e.g., message, email, etc.) back to the server 200, the triggering module 234 may trigger the second timer module 224₂ to stop its timer 240 and provide any appropriate data 227 related to the timer 240 to the analysis engine 232 for subsequent manipulation, storage, and presentation of related analytical data 236 to users via the dashboard 220 of the portal 216 (e.g., (e.g., timestamp of when the timer 240 ended, how long the timer 240 ran, etc.).

Upon or subsequent to ending of the timer 240 of the second timer module 224₂, the triggering module 234 may trigger one or more additional timer modules 224 to initiate their respective timers 240 for purposes of measuring the performance of additional stages or steps in the process of delivering the customer parts to the job site. While the timers 240 of various individual timer modules 224 may be started and stopped upon initiation and completion of various individual stages or steps of the process of delivering the customer parts to the job site, the timer 240 of the first timer module 224₁ may not end until the customer parts 304 are actually received at the job site. In this regard, the timers 240 of the second and/or additional timer modules may be considered “sub-timers” of the overall job timer 240 of the first timer module 224₁ that are configured to facilitate delivery of the assets to the job site before expiration of the overall job timer 240 of the first timer module 224₁. The customer 116 and/or organization 108 (e.g., administrators) may appropriately access the portal 216 to configure the triggering module 234, analysis engine 232, various timer modules 224, alert/message generator 244, etc. according to any desired preferences (e.g., such as to set a specific time period of a particular timer 240, create a new timer module 224, specify who is to receive escalation alerts upon expiration of a particular timer 240, etc.). In some arrangements, the customer 116 and/or organization may extend one or more of the timers 240 in an ad hoc fashion for any appropriate reasons (e.g., such as for one or more of a list of previously decided upon reasons for delay).

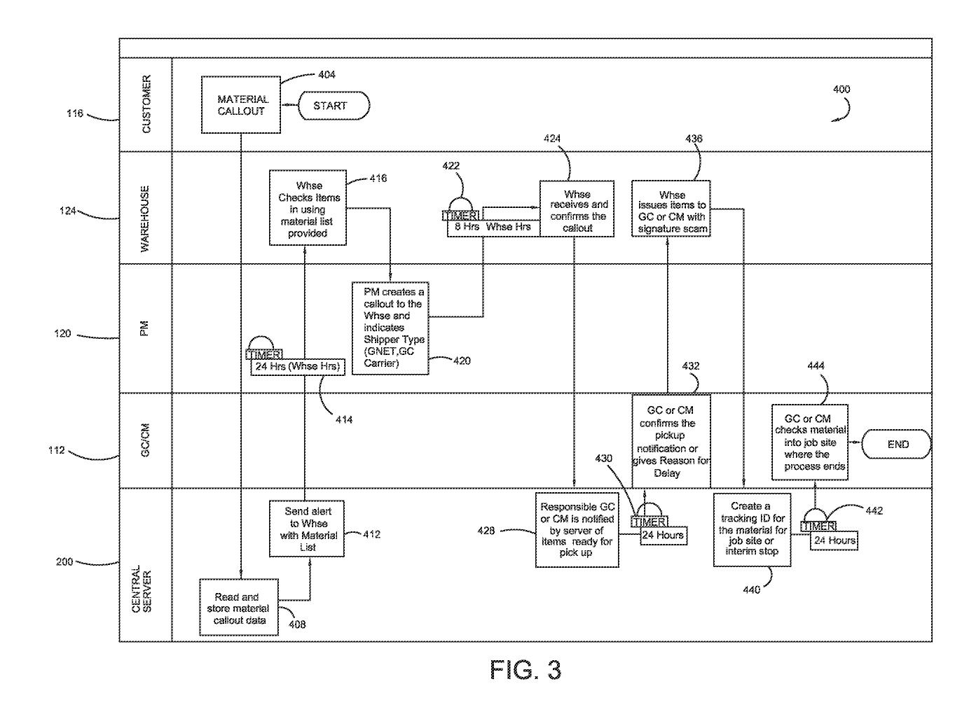

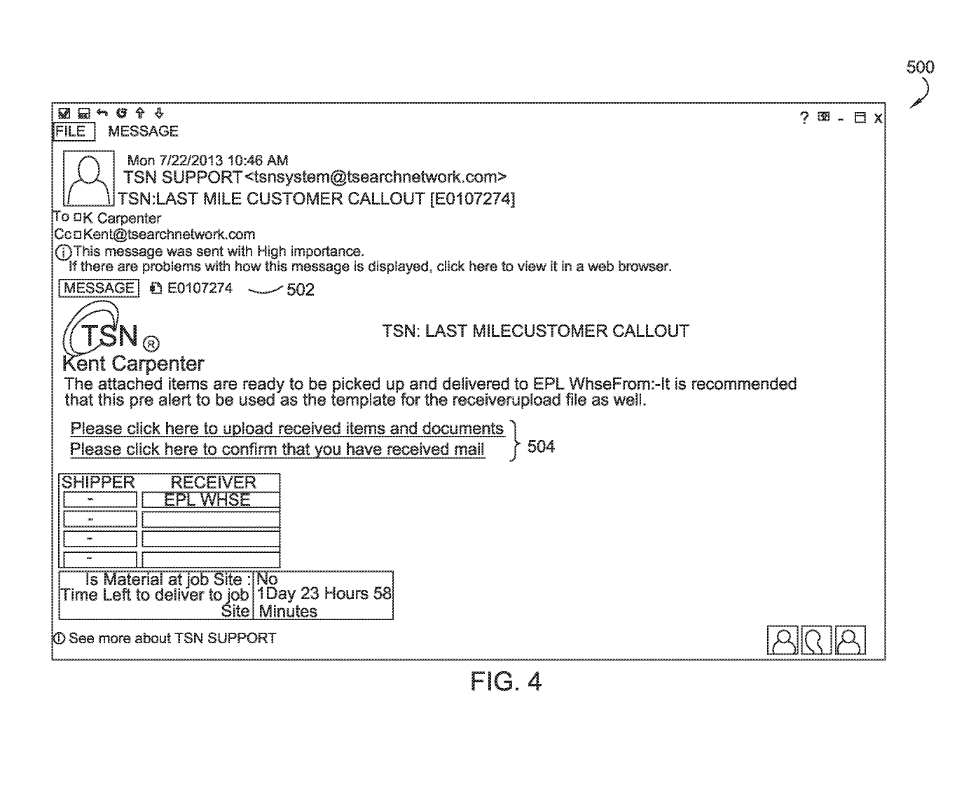

To facilitate the reader's understanding of the various modules and functionalities of the utilities disclosed herein, additional reference is now made to FIG. 3 which presents a swim lane diagram of a method 400 of tracking and monitoring materials called out by a customer for delivery to a job site according to an embodiment as well as to FIGS. 4-17 which present various screenshots presentable to various actors responsible for the movement of the customer materials to the job site (e.g., project manager 120, warehouse 124, GC/CM 112, etc.). While specific steps (and orders of steps) of the method 400 (as well as other methods disclosed herein) have been illustrated and will be discussed, other methods (including more, fewer or different steps than those illustrated) consistent with the teachings presented herein are also envisioned and encompassed within the present disclosure.

At step 404, the method 400 may begin by a customer 116 generating and sending a material callout 300 to the central server 200 where the central server 200 may read and store 408 the material data in storage 212. For instance, the customer 116 may generate and attach a file (e.g., a Microsoft® Excel® spreadsheet or the like) to an email including an itemized list of parts for pickup from the customer's location (e.g., including part numbers or IDs, descriptions, quantities, etc.) along with any appropriate related metadata such as project ID, job site, job site location, project manager, etc. Upon receipt, the central server 200 (e.g., analysis engine 232, portal 216 etc.) may appropriately parse the material data and related metadata out of the material callout 300 and store the same in storage 212 (e.g., such as by storing the parts data in parts database 252, the metadata in metadata database 256, etc.). In one arrangement, the customer 116 may push the material callout 300 directly to the central server (e.g., to any appropriate email address associated with the central server 200 or to which the central server 200 has access). In another arrangement, the customer 116 may send the material callout 300 to the organization 108 (e.g., to any appropriate email address of the organization) which may proceed to push or otherwise send the material callout 300 to the central server 200.

As discussed herein, the server 200 implements a number of timer modules 224 that are configured to initiate a respective plurality of timers for various aspects or stages of the movement of assets or parts to a job site. In this regard, generation of the material callout 300 by the customer 116 may signal the triggering engine 234 to trigger one of the timer modules 224 (e.g., the first timer module 224₁) to automatically initiate its timer 240 (e.g., an overall job timer) that sets forth a first particular period of time within which the particular materials are to be received at the job site. For instance, the timer 240 of the first timer module 224₁ may be set to run for up to a particular period of time (e.g., 7 days, 14 days, etc.) from a time stamp of the material callout 300 generated and sent by the customer 116 and may not stop until the customer parts 304 are actually received at the job site (e.g., as determined by the GC/CM uploading a pickup confirmation message to the server 204 via the portal 216, discussed in more detail below).

In any case, the method 400 of FIG. 3 may also include generating and sending 412 an alert to the warehouse 124 that includes a list of materials received in the material callout 300 from the customer 116 and informing the warehouse 124 that the materials are to be picked up from the customer's location and checked in to the warehouse 124 within a particular period of time (e.g., 24 hours from a timestamp of the alert sent to the warehouse 124). For instance, the triggering module 234 may trigger the alert/message generator 244 to generate and send a material pickup notification 306 (see FIG. 2, e.g., message, email, etc.) to the warehouse 124 (e.g., to any appropriate representative or user of the warehouse 124) that the parts are to be picked up from the customer's location while substantially simultaneously triggering the second timer module 224₂ to initiate its timer 240 (e.g., timer 414 of FIG. 3) to run for the particular period of time (e.g., for 24 hours from the timestamp of the material pickup notification 306 sent to the warehouse 124).

For instance, FIG. 4 presents a screenshot 500 of a material pickup notification 306 (e.g., email or other message) that may be automatically generated by the alert/message generator 244 of the central server 200 and sent to one or more appropriate representatives of the warehouse 124 for receipt on a display of any appropriate computing device (e.g., tablet, smartphone, desktop, laptop). As shown, the material pickup notification 306 may include a file or attachment 502 (e.g., Microsoft® Excel® spreadsheet or the like) that includes the list of materials (and related metadata) being called out by the customer 116. In one variation, the list of materials and related metadata may be included directly in the body of the message. In any case, the material pickup notification 306 may also include one or more links 504 for manipulation by the recipient of the material pickup notification 306. For instance, manipulation of one of the links 504 may automatically generate and send a message to the central server 200 (e.g., to the portal 216) confirming that the material pickup notification 306 has been received.

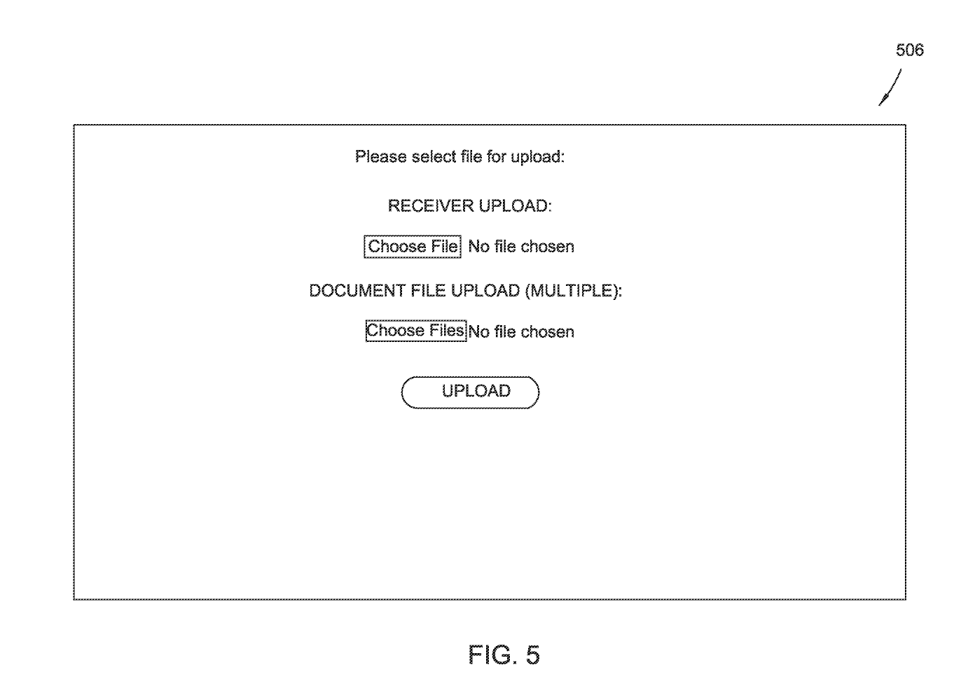

After pickup of the materials from the customer's location, the method 400 may proceed to check-in 416 the customer materials at the warehouse 124. For instance, the recipient of the material pickup notification 306 may manipulate another of the links 504 in the screenshot 500 of FIG. 4 which may automatically direct the recipient web-page or the like that allows the recipient to upload a list of the checked-in materials to the central server 200 (e.g., via the portal 216). See screenshot 506 of FIG. 5. In one arrangement, the recipient may cross-check the checked-in materials against the material list in the attachment 502 of FIG. 4, make any necessary changes to reflect the actual materials checked-in, and then upload the list to the central server 200. Upon receipt of the uploaded list of checked-in materials from the warehouse 124, the triggering engine 234 may automatically trigger the second timer module 224₂ to end its timer 240 and send any appropriate data 227 or metrics to the analysis engine 232 (e.g., a timestamp of the above “event,” how long the timer 240 ran until the event occurred, etc.) for use in generating further metrics 228 for presentation to users via dashboard 220 of portal 216. In one arrangement, the portal 216 may parse any appropriate data 227 from the uploaded list of materials or other communication confirming check-in of the customer materials at the warehouse 124 (e.g., timestamps, etc.) and provide the same to the analysis engine 232.

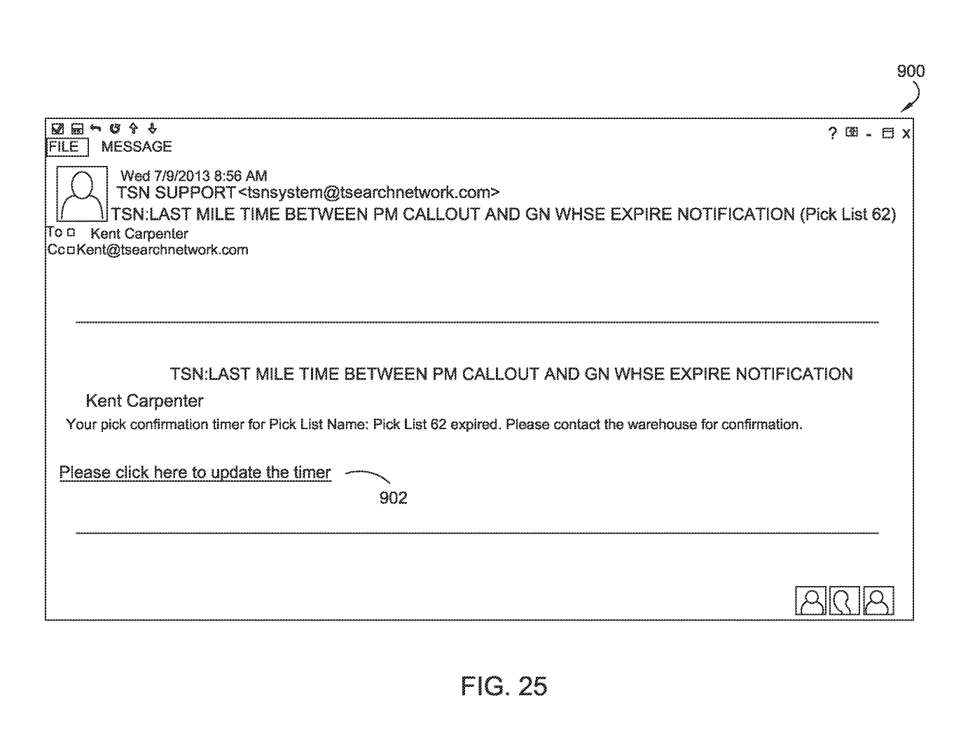

For instance, the analysis engine 232 may obtain or otherwise determine metrics 228 based on data 227 received from the second timer module 224₂ and/or portal 216 such as the time the assets were checked into the warehouse 124, the length of time the timer 240 of the 224₂ actually ran, whether or not the assets were checked into the warehouse 124 within the time period of the timer 240 of the second timer module 224₂, and the like. The analysis engine 232 may sometimes tag the obtained or determined data 227 and metrics 228 with any appropriate metadata (e.g., warehouse ID, warehouse location, customer ID, project ID, etc.). Additionally, the analysis engine 232 may appropriately update any statistical or workflow metrics 228 being maintained such as total number of lines of assets moved from the customer's location to the warehouse 124 (e.g., or other location of the organization 108), average time to move a line of assets from the customer's location to the warehouse 124, etc. In the event the customer materials are not checked into the warehouse 124 within the particular time period of the timer 240 of the second timer module 224₂, the second timer module 224₂ may be configured to generate any appropriate expired timer signal 226 which may be sent to the analysis engine 232 as well as to the triggering engine 234 to trigger the alert/message generator 224 to generate and send an expired timer alert 310 (e.g., email, text message, etc., see screenshot 900 of FIG. 25) to one or more appropriate parties (e.g., to project manager 120) to take any appropriate remedial action.

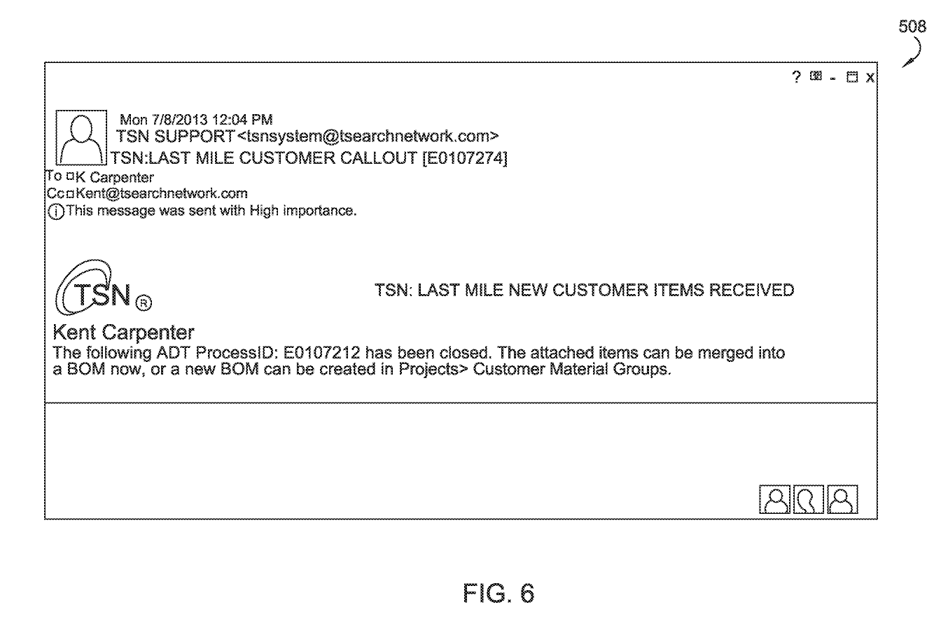

Assuming the materials are checked into the warehouse 124 within the time period of the timer 240 of the second timer module 224₂ (e.g., which may be considered completed upon upload of the materials to the central server 200), the method 400 may including automatically generating a material callout alert 312 (see FIG. 2, e.g., email, text message, etc.) and send the same to the project manager 120 associated with the project identified in the material callout 300 from the customer 116 (e.g., see screenshot 508 of FIG. 6). For instance, the triggering engine 234 may trigger the alert/message generator 244 to generate a material callout alert 312 informing the project manager 120 that there are materials at the warehouse 124 to be called out for pickup and delivery to the job site (e.g., by the GC/CM 112, by a shipping entity of the organization 108, etc.).

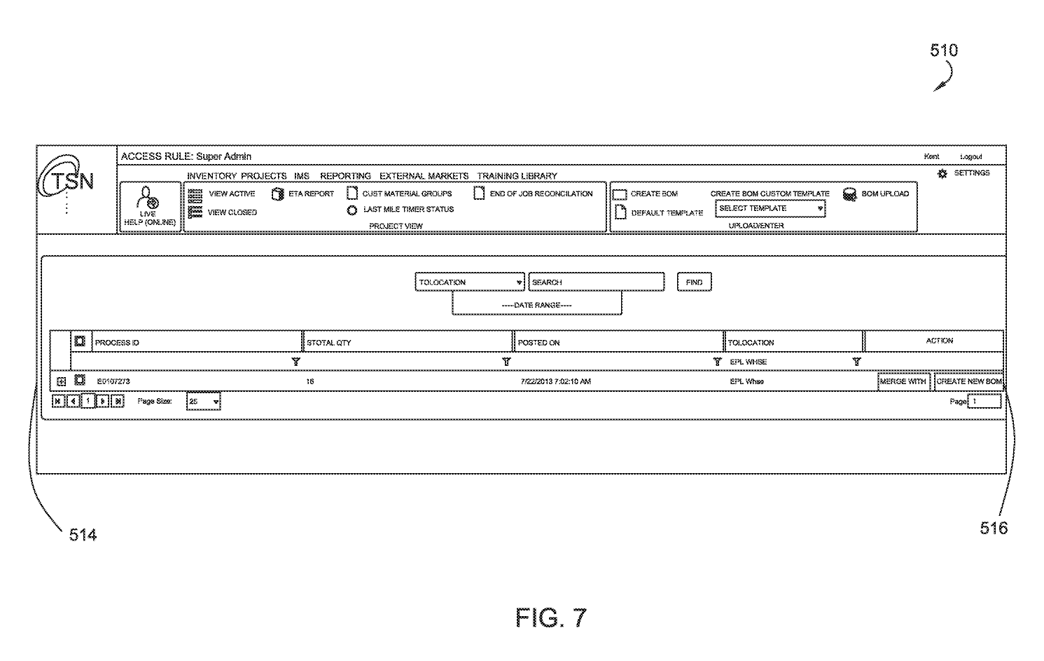

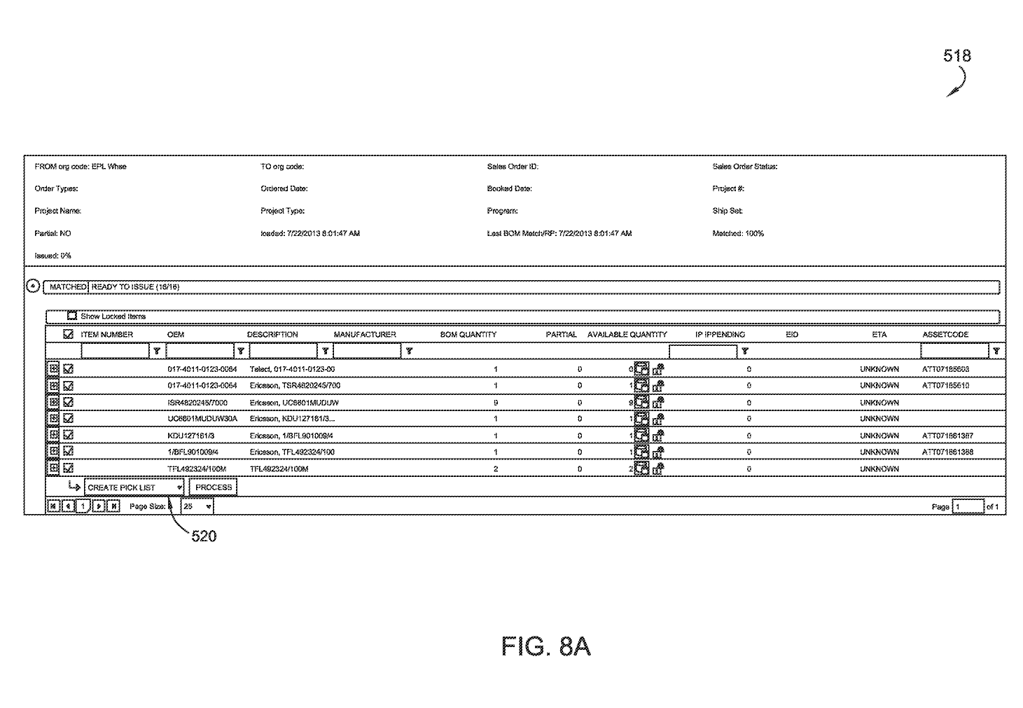

Upon receipt of the material callout alert 312, for instance, the method 400 may include creating 420 a material callout 316 (see FIG. 2) to be sent to the warehouse 124 for the customer materials and including the shipper type. As an example, the project manager 120 may initially create a material callout request 314 by way of accessing the portal 216 (e.g., via clicking a link in the material callout alert 312 and/or accessing the portal through any appropriate browser) and submitting the request 314 (see FIG. 2) for a material callout 316 to be sent to the warehouse 124. For instance, FIG. 7 presents a screenshot 510 of the portal 216 that allows the project manager 120 to take a number of different actions such as creating material callout requests 314 for material callouts 316 to be sent to one or more of the warehouses 124, accessing the reporting dashboard 220, etc. In the screenshot 510 of FIG. 7, a “projects” tab 512 has been selected that displays materials that have been called out by a customer 116 and checked into a warehouse 124 of the organization to be delivered to a job site.

More specifically, the screenshot 510 includes a list of equipment release forms (ERFs) 514 (only one shown in FIG. 7), where each row includes any appropriate metadata of the ERF 514 such as a total quantity of assets/parts included in the ERF 514 (e.g., 16 in this example), a location of the assets/parts included in the ERF 514 (e.g., “EPL Warehouse” in this example), and the like. As shown, the project manager 120 may manipulate buttons 516 to either merge the materials of this ERF 514 with an existing bill of materials (BOM) or create a new BOM with the materials (e.g., BOMs as discussed in U.S. Pat. No. 8,650,101, entitled “INTERNAL MATERIAL SYSTEM FOR FACILITATING MATERIAL AND ASSET MOVEMENT WITHIN ORGANIZATIONAL INFRASTRUCTURES,” assigned to the Assignee of the present application, filed on Oct. 3, 2011, and issued on Feb. 11, 2014; the entirety of this application is incorporated herein by reference).

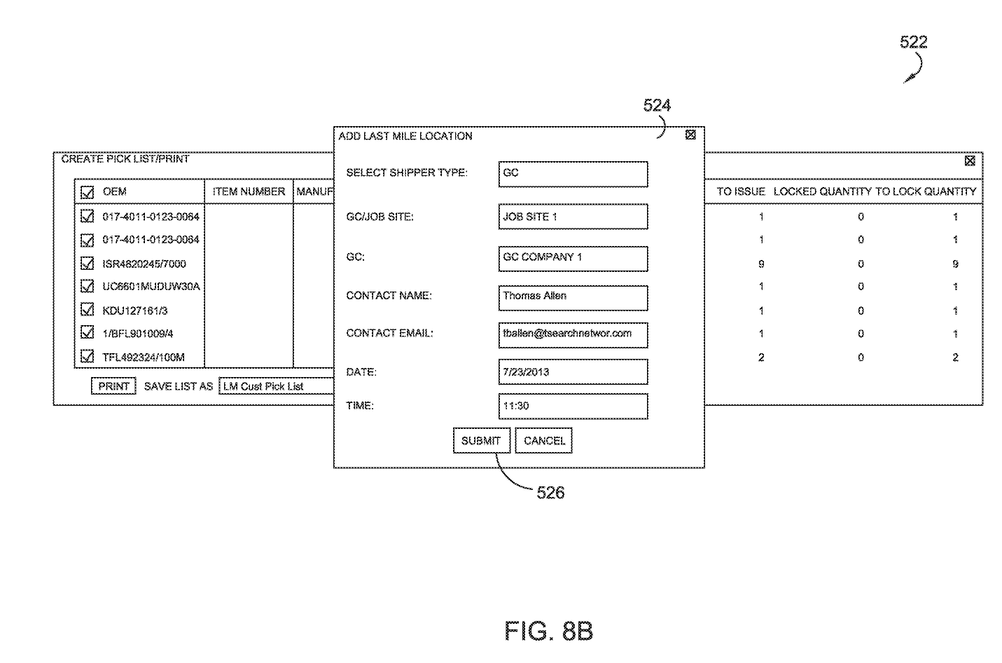

FIG. 8a presents a screenshot 518 of the portal 216 that displays a list of the assets of the particular ERF 514 selected in FIG. 7 (e.g., where each row of the list includes various metadata for the asset(s) such as OEM part number, description, quantity, and/or the like). FIG. 8a presents a screenshot 518 of the portal 216 that allows the project manager 120 or the like to select the particular shipping entity to pick up the assets of the ERF 514 from the warehouse 124. For instance, upon manipulation of user manipulable feature 520 (e.g., “Create Pick List” button) in FIG. 8a, the project manager 120 or the like may be presented with the window 524 in the screenshot 522 of FIG. 8b that allows the project manager 120 to select the shipper type (e.g., GC, internal shipping entity of the organization 108, etc.), the job site (e.g., where the assets are to be delivered), the shipping entity name, contact information, and a pickup date and time (i.e., the date and time by which the shipping entity is to pick up the assets). Upon manipulation of user manipulable feature 526 (e.g., button), the portal 216 of the server 200 may appropriately store the various information and/or metadata associated with this material callout request 314 (e.g., assets, quantities, shipper type, shipper name, etc.) in storage 212 and send any appropriate signal regarding the same to the triggering engine 234 for purposes of generating and sending a corresponding material callout 316 to the warehouse 124.

As an example, the triggering engine 234 may, in response to the signal received from the portal 216, trigger the alert/message generator 244 to generate and send a corresponding material callout 316 tagged with one or more appropriate identifiers (e.g. a BOM process ID), a timestamp indicating a creation of the material callout, etc. to the warehouse 124. The alert/message generator 244 may send or otherwise provide any appropriate data 227 and/or metrics 228 regarding the same to the analysis engine 232 and/or to storage 212. At substantially the same time that the material callout 316 is generated and sent to the warehouse 124, the triggering engine 234 may trigger a third timer module 224₃ (not shown) of the server 200 to initiate its timer 240 (e.g., timer 422 of FIG. 3) setting forth a third period of time (e.g., as measured from the timestamp of this material callout 316) within which the warehouse 124 is to confirm receipt of the material callout 316.

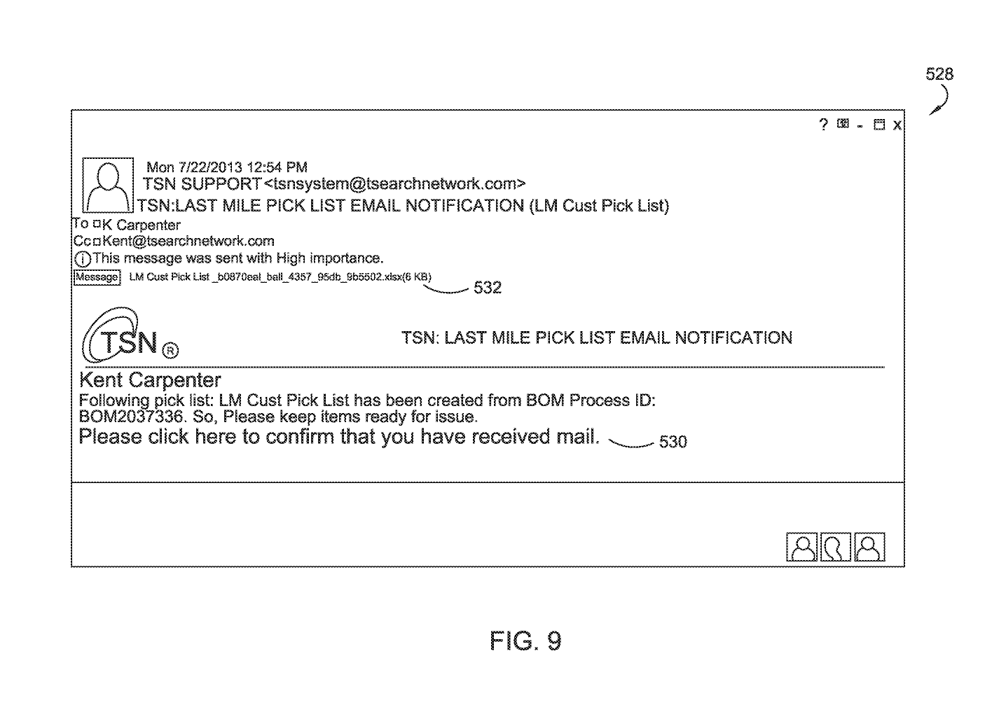

As an example, FIG. 9 presents a screenshot 528 of a material callout 316 (e.g., email or the like) sent to any appropriate representative of the warehouse 124. For instance, the material callout 316 may include an attachment 532 that includes a list of the assets to be picked up from the warehouse 124 by the shipping entity (e.g., by GC/CM 112 in this example). In one arrangement, the shipping entity, pickup date and time, etc. may be specified directly in the body of the material callout 316 (not shown in FIG. 9). In another arrangement, the aforementioned information may be specified in the attachment 532 and/or may be located by accessing the portal 216 using any appropriate credentials and selecting the projects tape 512 (e.g., see tab 512 in FIG. 7) to view active projects or the like.

As shown in FIG. 3, the method 400 may then include the warehouse 124 receiving and confirming 424 the material callout 316. For instance, the screenshot 528 of the material callout 316 of FIG. 9 may also include a button or link 530 that, when manipulated, automatically sends a receipt confirmation 318 (see FIG. 2) back to the server 200 (e.g., through the portal 216) that ends the timer 240 of the third timer module 224₃ (e.g., via the portal 216 signaling the triggering module 234 to trigger the third timer module 224₃ to end its timer 240). Like with other timer modules 224 disclosed herein, the third timer module 224₃ may automatically send any appropriate data 227 or metrics to the analysis engine 232 (e.g., a timestamp of the above “event,” how long the timer 240 ran until the event occurred, etc.) for use in generating further metrics 228 for presentation to users via dashboard 220 of portal 216. In one arrangement, the portal 216 may parse any appropriate data 227 from the receipt confirmation 318 (e.g., timestamps, etc.) and provide the same to the analysis engine 232. As discussed previously, the analysis engine 232 may obtain or otherwise determine metrics 228 based on data 227 received from the third timer module 224₃ and/or portal 216, tag the obtained or determined data 227 and metrics 228 with any appropriate metadata (e.g., warehouse ID, warehouse location, customer ID, project ID, etc.), update any statistical or workflow metrics 228 being maintained, and/or the like.

Upon receipt of the material callout receipt confirmation 318 from the warehouse 124, the server 200 may then appropriately notify 428 the responsible GC/CM 112 that assets are ready for pickup from the warehouse 124. As an example, the triggering engine 234 may trigger the alert/message generator 244 to generate and send a corresponding material pickup notification 320 (see FIG. 2) to the GC/CM 112 previously selected in the material callout request 314 alerting the GC/CM 112 that the specific materials/assets in the material callout 316 are to be picked up from the warehouse 124 by the particular date and time previously selected in the material callout request 314. In one embodiment, the triggering engine 234 may, at substantially the same time that the material pickup notification 320 is generated and sent to the GC/CM 112, trigger a fourth timer module 224₄ (not shown) of the server 200 to initiate its timer 240 (e.g., timer 430 of FIG. 3) setting forth a fourth period of time (e.g., as measured from the timestamp of this material pickup notification 320) within which the GC/CM 112 is to either confirm the material pickup notification 320 (i.e., confirm that the GC/CM 112 will pick up the assets by the particular date and time indicated in the material pickup notification 320) or submit/provide a reason for delay and a proposed new date and/or time to pick up the assets from the warehouse 124.

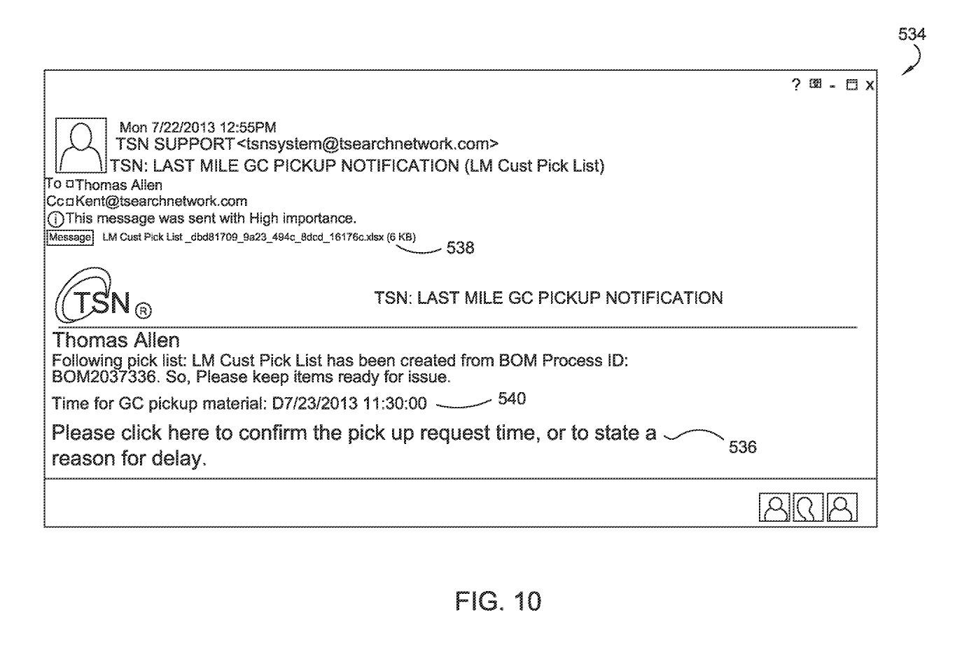

FIG. 10 presents a screenshot 534 of a material pickup notification 320 (e.g., email or the like) generated by the alert/message generator 244 of the server 200 and sent to any appropriate representative of the GC/CM 112 previously identified in the material callout request 314. For instance, the material pickup notification 320 may include an attachment 538 that includes a list of the assets to be picked up from the warehouse 124 by GC/CM 112 (e.g., the same as or similar to the attachment 532 of FIG. 9). The material pickup notification 320 may also include the date and time 540 by which the assets/materials are to be picked up from the warehouse 124 and the specific name and/or location of the warehouse 124 from which the assets are to be picked up (not shown).

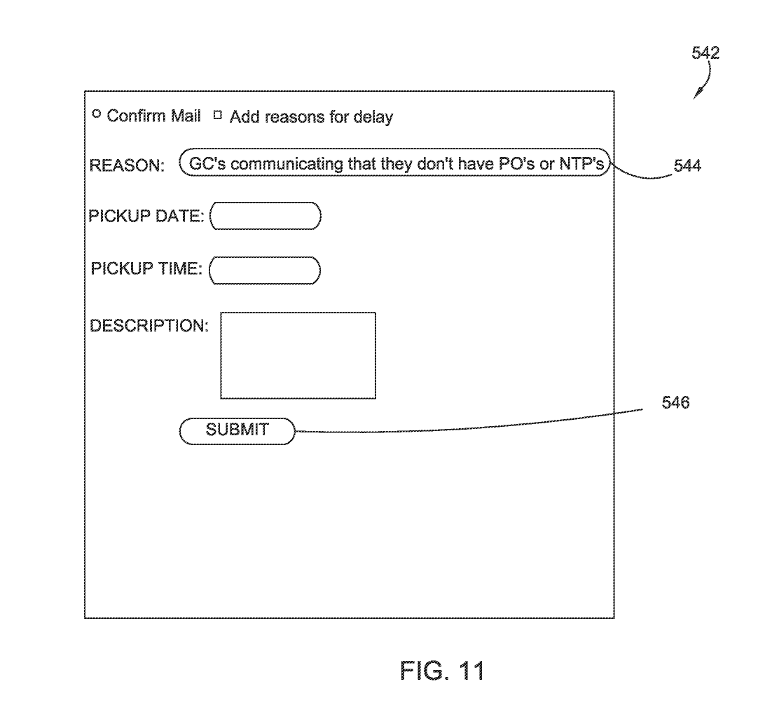

As shown in FIG. 3, the method 400 may then include the GC/CM 112 either confirming 432 the material pickup notification 320 or providing a reason for delay and a proposed new date and/or time to pick up the assets from the warehouse 124. For instance, the screenshot 534 of FIG. 10 may include a button or link 536 that, when manipulated, directs the user (the representative of the GC/CM 112) to the screenshot 542 of FIG. 11 that allows the user to confirm the material pickup notification 320 or submit/provide a reason for delay. As an example, the screenshot 542 of FIG. 11 may include a drop-down list 544 of reasons for delay that were previously agreed upon between the GC/CM 112 and the organization 108 and/or the customer 116.

After either choosing to confirm the date and time specified in the material pickup notification 320 or selecting a reasons for delay and a proposed new pickup date and time, manipulating of a “Submit” button 546 sends a pickup confirmation message 322 or a reasons for delay message 324 (see FIG. 2) back to the server 200 (e.g., via the portal 216) that signals the triggering engine 234 to trigger fourth timer module 224₄ to end its timer 240. Like with other timer modules 224 disclosed herein, the fourth timer module 224₄ may automatically send any appropriate data 227 or metrics 228 to the analysis engine 232 (e.g., a timestamp of the above “event,” how long the timer 240 ran until the event occurred, etc.) for use in generating further metrics 228 for presentation to users via dashboard 220 of portal 216. In one arrangement, the portal 216 may parse any appropriate data 227 from the pickup confirmation message 322 or reasons for delay message 324 (e.g., timestamps, etc.) and provide the same to the analysis engine 232. As discussed previously, the analysis engine 232 may obtain or otherwise determine metrics 228 based on data 227 received from the fourth timer module 224₃ and/or portal 216, tag the obtained or determined data 227 and metrics 228 with any appropriate metadata (e.g., warehouse ID, warehouse location, customer ID, project ID, etc.), update any statistical or workflow metrics 228 being maintained, and/or the like.

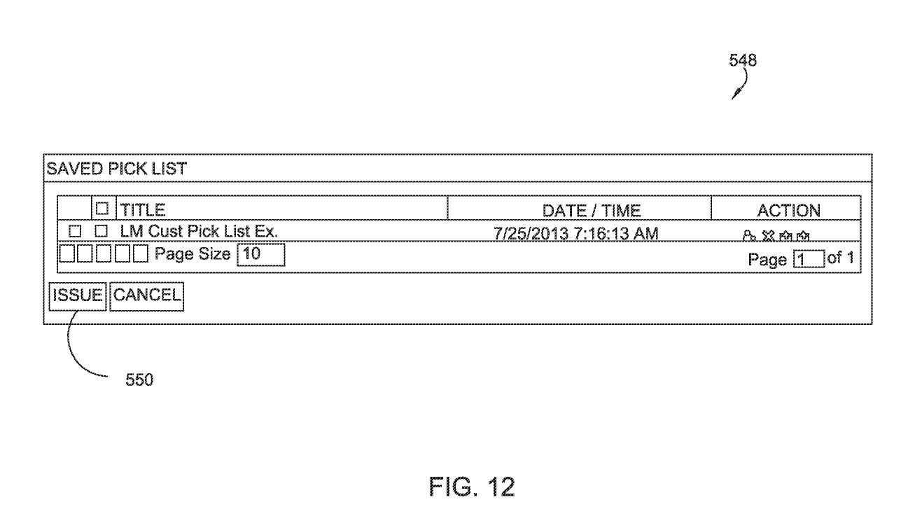

The method 400 of FIG. 3 may continue by the warehouse 124 issuing 436 the assets to the GC/CM 112, such as by the GC/CM 112 taking possession of the assets from the warehouse 124 and the warehouse 124 obtaining a signature scan or the like from the GC/CM 112. For instance, FIG. 12 presents a screenshot 548 of a list of “pick lists” (only one shown in FIG. 12) that the warehouse 124 (e.g., the representative of the warehouse) may access through the portal 216, where each pick list includes a specific list of assets of a particular material callout request 314 to be picked up by a particular shipping entity (e.g., by the GC/CM 112). In this regard, the warehouse representative may select the pick list corresponding to the assets to be picked up by the GC/CM 112 and then manipulate an “issue” button 550 or the like to begin the issue process.

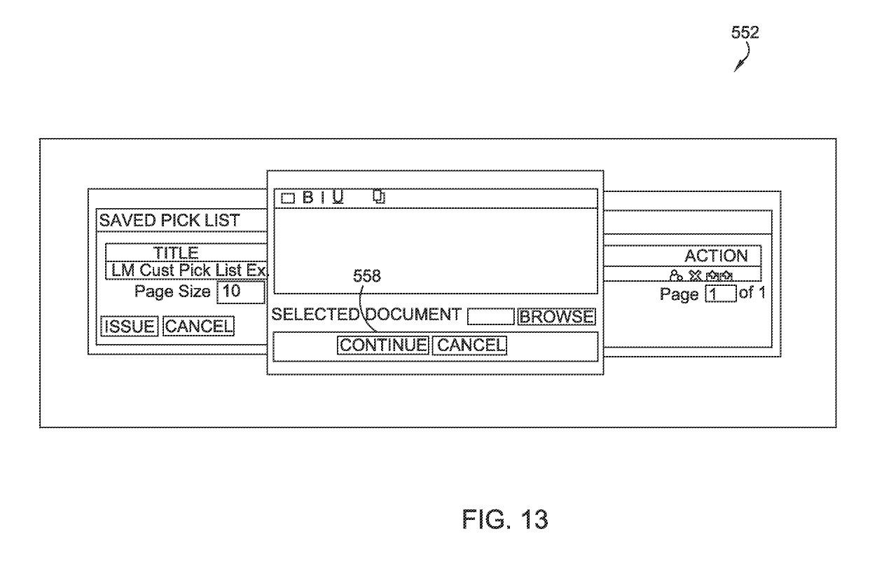

The warehouse representative may then be directed to the screenshot 552 of FIG. 13 whereby the warehouse representative may be prompted to select any appropriate signature scan or the like of the GC/CM for upload to the server 200. Upon manipulating a “continue” button 554 or the like, a material issue notification 326 (see FIG. 2) may be automatically generated and sent to the server 200 for storage in storage 212. For instance, the portal 216 may parse a timestamp and/or any other appropriate data 227 and/or metrics 228 out of the material issue notification 326 and send the same to the analysis engine 232 to determine whether or not the materials were picked up by the date and time in the material pickup notification 320 or in the reasons for delay message 324.

In one arrangement, the method 400 of FIG. 3 may include creating 440 (e.g., by any appropriate module or engine of the server 200) any appropriate tracking ID (e.g., at substantially the same time the material issue notification 326 is received at the server 200) or the like for the materials picked up by the GC/CM 112 for delivery to the job site or to one or more interim stops before reaching the job site. In conjunction with steps 436 and 440 of the method 400, the triggering engine 234 may trigger a fifth timer module 224₅ (not shown) of the server 200 to initiate its timer 240 (e.g., timer 442 of FIG. 3) setting forth a fifth period of time (e.g., as measured from the timestamp of material issue notification 326) within which the GC/CM 112 is to check in the materials picked up from the warehouse 124 at the job site. In any case, the method 400 may eventually include the GC/CM 112 (or other shipping entity) checking in 444 the materials at the job site.

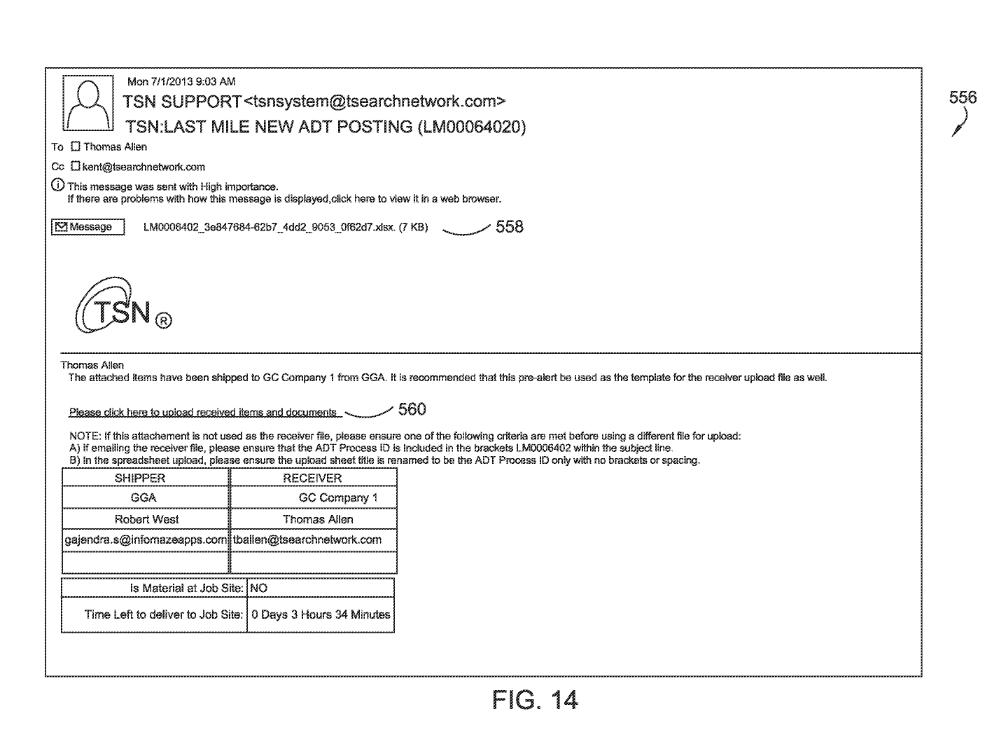

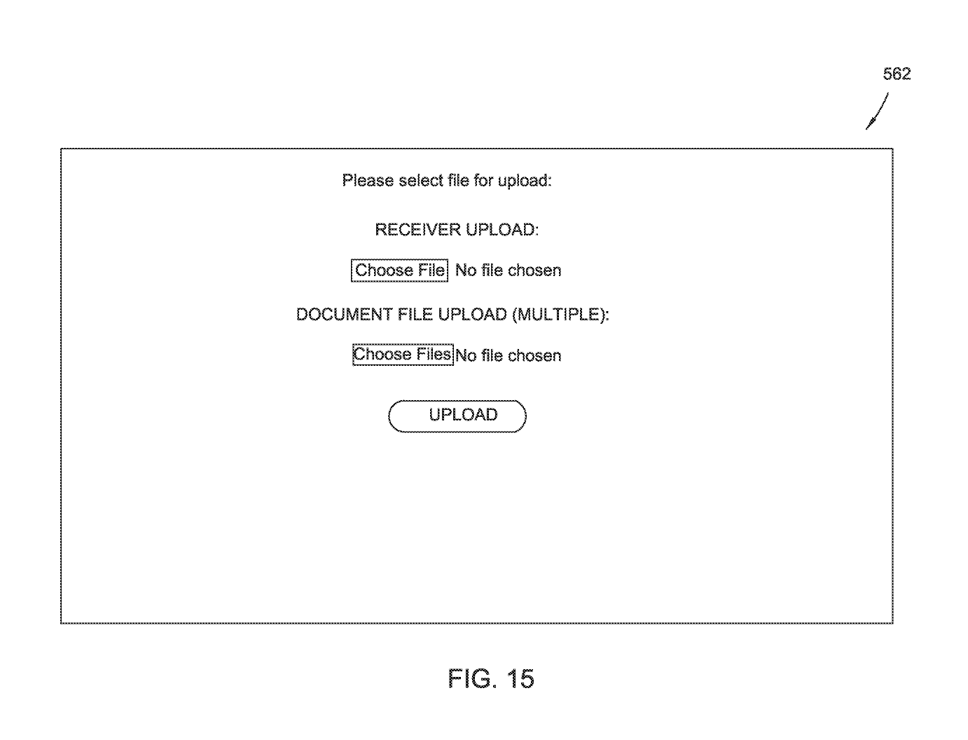

For instance, FIG. 14 presents a screenshot 556 of a material “pre-alert” notification 328 (see FIG. 2) that may be automatically generated and sent by the server 200 to the GC/CM 112 substantially simultaneously with steps 436 and 440 of the method 400. For instance, the triggering engine 234 may trigger the alert/message generator 244 to generate and send the pre-alert notification 328 at substantially the same time the triggering engine 234 triggers the fifth timer module 224₅. As shown, the screenshot 556 may include an attachment 558 that includes a list of the assets (e.g., including part numbers, quantities, etc.) issued to the GC/CM 112 by the warehouse 124 as well as a button or link 560 that, when manipulated, directs the user to the screenshot 562 of FIG. 15 that allows the user to upload a specific list of assets being checked in at the job site to the server 200 (e.g., via the portal 216). In one arrangement, the user may download the attachment 558 of FIG. 14, make any necessary modifications to reflect the assets actually being checked in, and then upload the attachment to the server 200. Upon upload of the checked in assets, a material check-in notification 330 (see FIG. 2) including the uploaded list of assets may be automatically generated and sent to the server 200 that signals the triggering module 234 to end the timer 240 of the fifth timer module 224₅. Like with other timer modules 224 disclosed herein, the fifth timer module 224₅ and/or the portal 216 may automatically obtain and send any appropriate data 227 or metrics 228 to the analysis engine 232 which may analyze the received information to determine various additional metrics 228, tag the obtained or determined data 227 and metrics 228 with any appropriate metadata (e.g., warehouse ID, warehouse location, customer ID, project ID, etc.), update any statistical or workflow metrics 228 being maintained, and/or the like.

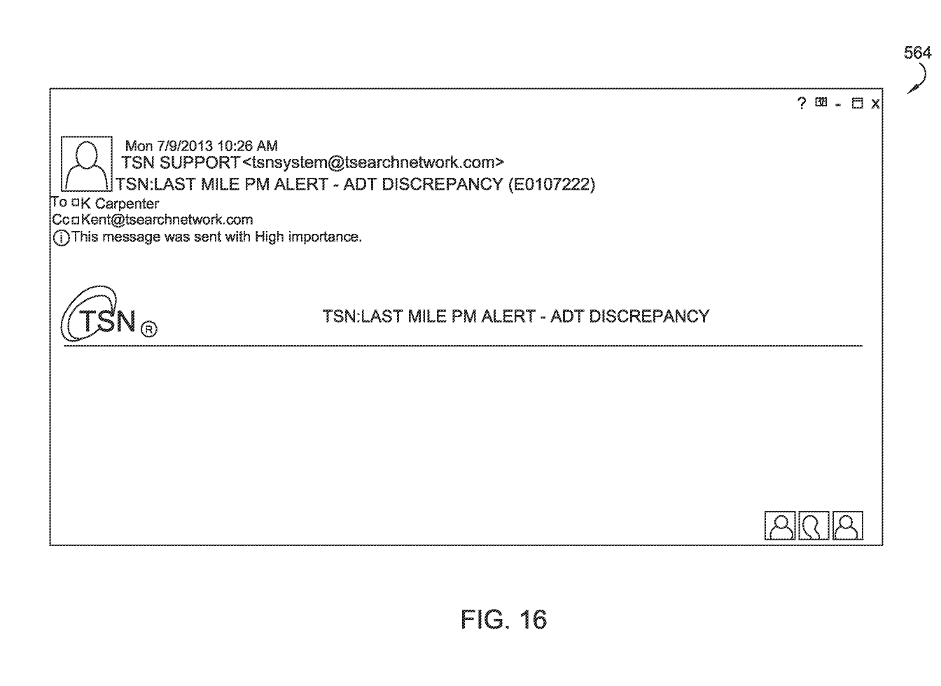

In one arrangement, the server 200 may be configured to automatically determine whether any discrepancies or variances exist between the assets issued to the GC/CM 112 (or other shipping entity) at the warehouse 124 and the assets checked into the job site and send corresponding material variance alerts 332 to the project manager 120, the GC/CM 112 and/or other parties regarding the same. For instance, an asset variance module 260 of the server 200 may be configured to automatically cross-check the list of assets in each material check-in notification 330 against the list of assets in its corresponding material issue notification 326, determine whether any variances exist (e.g., assets issued but not checked in, assets check in but never issued, etc.), store the same in storage 212, and trigger the alert/message generator 244 to generate and send a corresponding material variance alert 332 to the project manager 120 regarding the same. For instance, see screenshot 564 of FIG. 16.

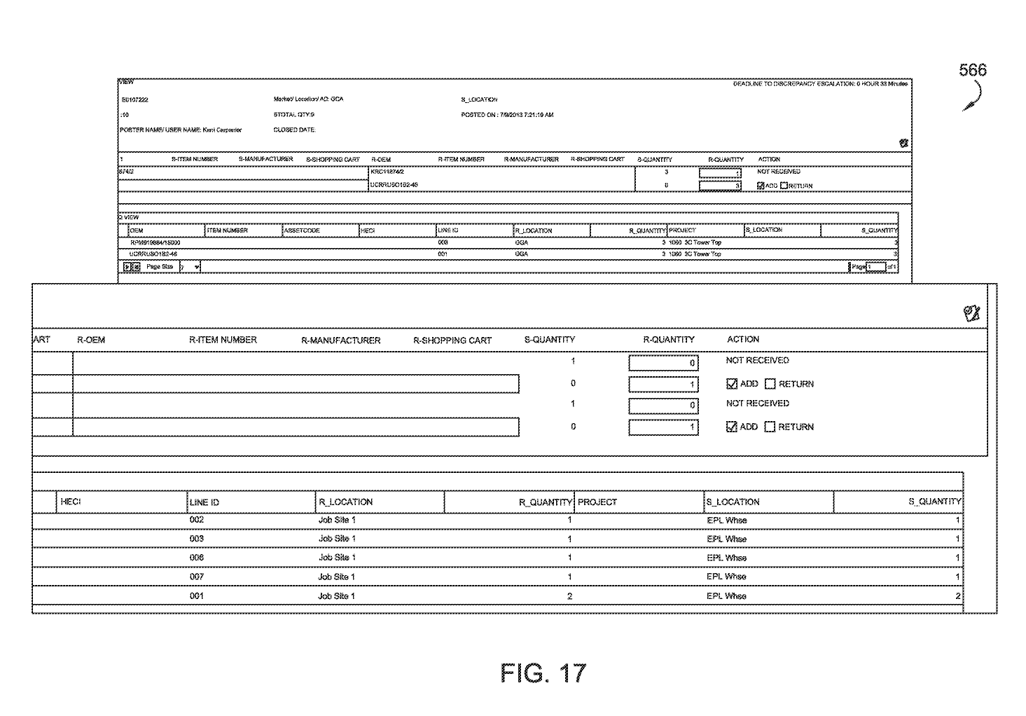

The screenshot 564 may include a link to portal 216 or otherwise prompt the project manager 120 to access the portal 120 to view the determined discrepancies and reconcile the same. For instance, see screenshot 566 of FIG. 17. In one arrangement, the triggering module 234 may trigger a sixth timer module 224₆ (not shown) to initiate its timer 240 setting forth a sixth period of time (e.g., as measured from a timestamp of material variance alert 332) within which the project manager 120 is to send a communication or message to the server 200 that the variance has been appropriately reconciled. In one arrangement, the GC/CM 112 may receive variance notifications 346 from the asset variance module 260 after check-in 444 of the assets at the job site and be able to send the same to the project manager 120 (e.g., via the server 200). In any event, the triggering module 234 may trigger the first timer module 224₆ to end its timer 240 upon receiving a signal from the portal 216 or the like that the assets have been checked into the job site and any asset discrepancies have been reconciled. Again, data 227 and metrics 228 may be collected and generated and provided to the analysis engine 232 for generation and storage of related analytical data 236 in storage 212 for presentation to users via dashboard 220 of portal 216.

As mentioned previously, expiry of any of the timers 240 of the timer modules 224 disclosed herein triggers the respective timer modules 224 to simultaneously generate expired timer signals 226 and send the same to the alert/message generator 244 (e.g., via the triggering engine 234 and/or in other manners) to automatically generate and send a corresponding alert (e.g., email, text message, etc.) to the project manager 120 and/or to any other appropriate parties (e.g., supervisors, administrators) that a particular event (e.g., warehouse 124 confirming a callout, GC/CM 112 confirming pickup time or providing reasons for delay, etc.) has not occurred as scheduled. For instance, one or more timers 240 of one or more additional timer modules 224 may be initiated setting forth respective periods of time within which the project manager 120 or the like needs to address the corresponding situation and correspondingly delaying the initiation of timers 240 of subsequent timer modules 224. In one arrangement, however, the timer 240 of the first timer module 224₁ (setting forth the overall period of time set by the customer within which the parts must be delivered to the job site) may continue to run thus encouraging the project manager 120 or the like to address any expired timers 240.

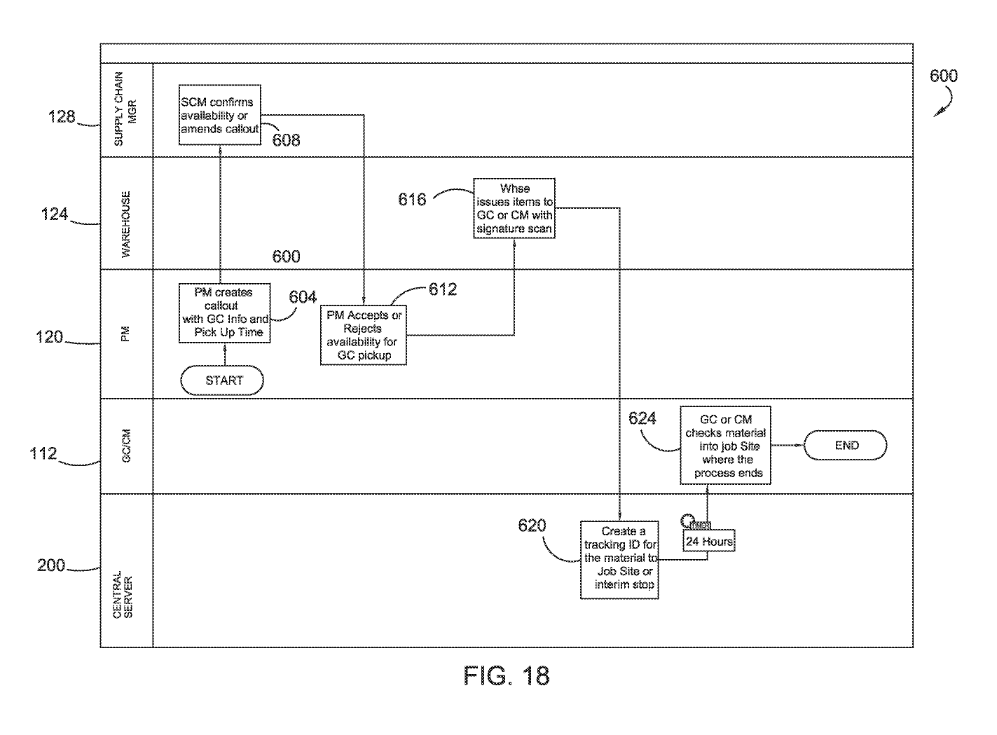

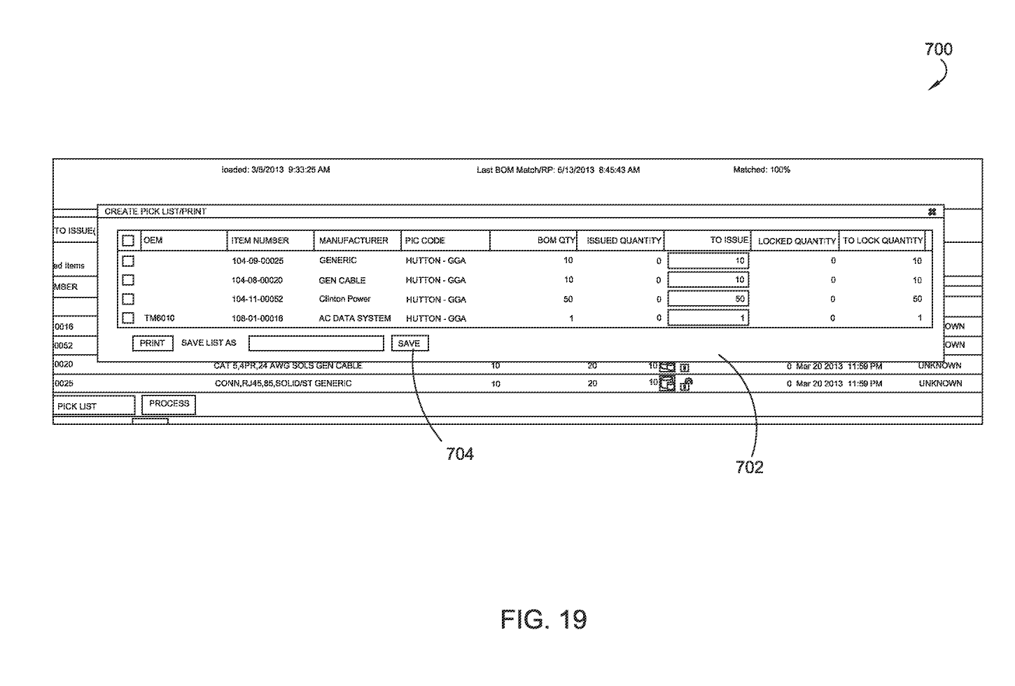

Reference is now made to FIG. 18 which presents a swim lane diagram of a method 600 of tracking and monitoring materials of the organization 108 called out by a project manager (or other party representing the organization 108) for delivery to a job site according to an embodiment as well as to FIGS. 19-23 which present various screenshots presentable to various actors responsible for the movement of the organization's materials to the job site (e.g., project manager 120, warehouse 124, GC/CM 112, etc.). In one embodiment, the method 600 may begin by creating 604 a material callout 316 (see FIG. 2) to be sent to the warehouse 124 for the organization's materials, where the material callout 316 includes the shipper type and name, pickup date and time, and/or the like. As an example, the project manager 120 or the like may initially create a material callout request 314 by way of accessing the portal 216 (e.g., through any appropriate browser) and submitting the request 314 (see FIG. 2) to the server 200.

For instance, the project manager 120 may access any existing BOM of a particular project being carried out by the organization 108 for the customer 116 and select one or more items in the BOM for inclusion in the material callout 316. FIG. 19 presents an exemplary screenshot 700 of a “pick list” of assets 702 selected from an existing BOM for inclusion in a material callout 316 to be sent to the warehouse 124. Upon manipulation of a “save” button 704 or the like, the user (e.g., the project manager 120) may be prompted to select the shipper type (e.g., GC, internal shipping entity of the organization 108, etc.), the job site (e.g., where the assets are to be delivered), the shipping entity name, contact information, a pickup date and time (i.e., the date and time by which the shipping entity is to pick up the assets), etc. See screenshot 522 of FIG. 8b.

Upon manipulation of user manipulable feature 526 (e.g., button), the portal 216 of the server 200 may appropriately store the various information and/or metadata associated with this material callout request 314 (e.g., assets, quantities, shipper type, shipper name, etc.) in storage 212 and send a signal regarding the same to the triggering engine 234 for purposes of generating and sending a corresponding material callout 316 to the warehouse 124. For instance, the triggering engine 234 may trigger the alert/message generator 244 to generate and send a corresponding material callout 316 to the warehouse 124 (e.g., see screenshot 528 of FIG. 9), trigger the alert/message generator 244 to generate and send a material pickup notification 320 to the shipper (e.g., GC)(e.g., see screenshot 534 of FIG. 10), trigger various timer modules 224 to initiate their timers 240, etc. until the assets are eventually checked into the job site, all as previously discussed in relation to the method 400 of FIG. 3 (e.g., where data 227 and metrics 228 are appropriately generated, collected, stored, and presented to users via portal 216).

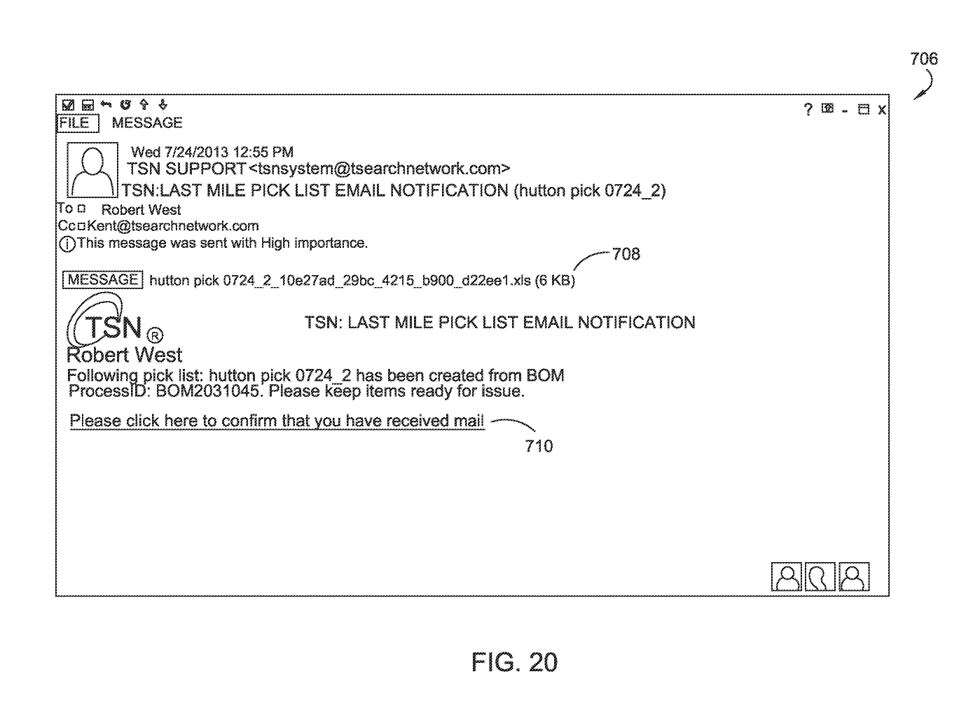

In one variation, the method 600 of FIG. 18 may include any appropriate supply chain manager 128 (not shown in FIG. 2) confirming 608 availability of the assets being called out by the project manager 120 in the material callout request 314 before the material callout 316 is sent to the warehouse 124. For instance, the triggering engine 234 of the central server 200 may trigger the alert/message generator 244 to generate and send a material callout alert (e.g., email, text message, not shown) to the supply chain manager 128. For instance, FIG. 20 presents a screenshot 706 of such a material callout alert that has an attachment 708 including the list of materials being called out by the project manager 120 and a button or link 710 that allows the supply chain manager or other appropriate party to confirm receipt of the material callout alert and amend or approve the material callout.

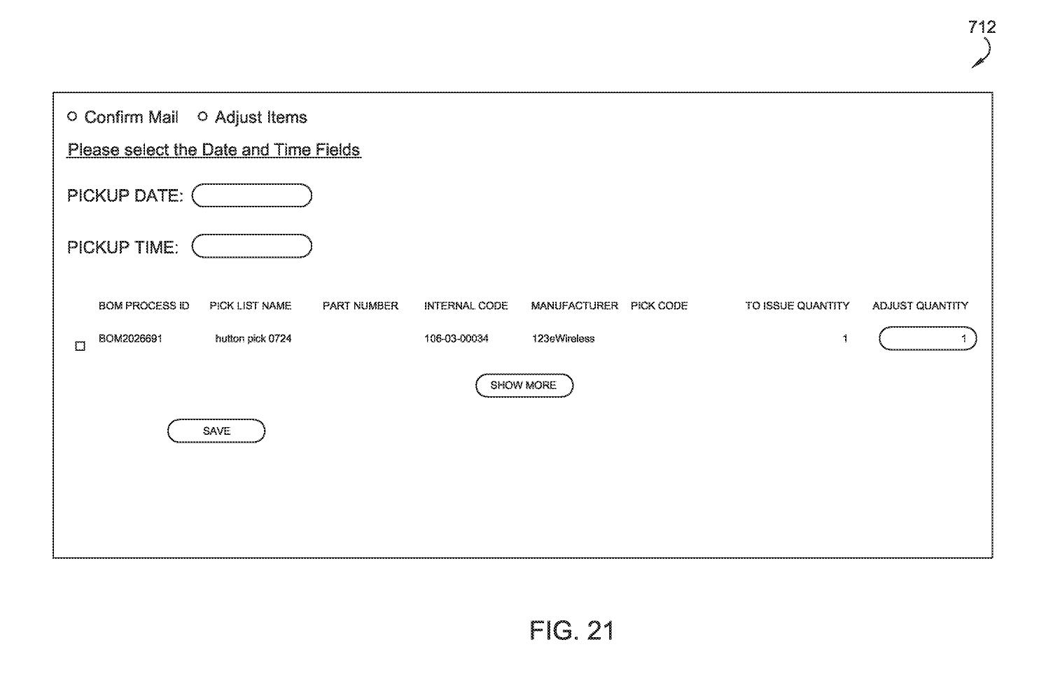

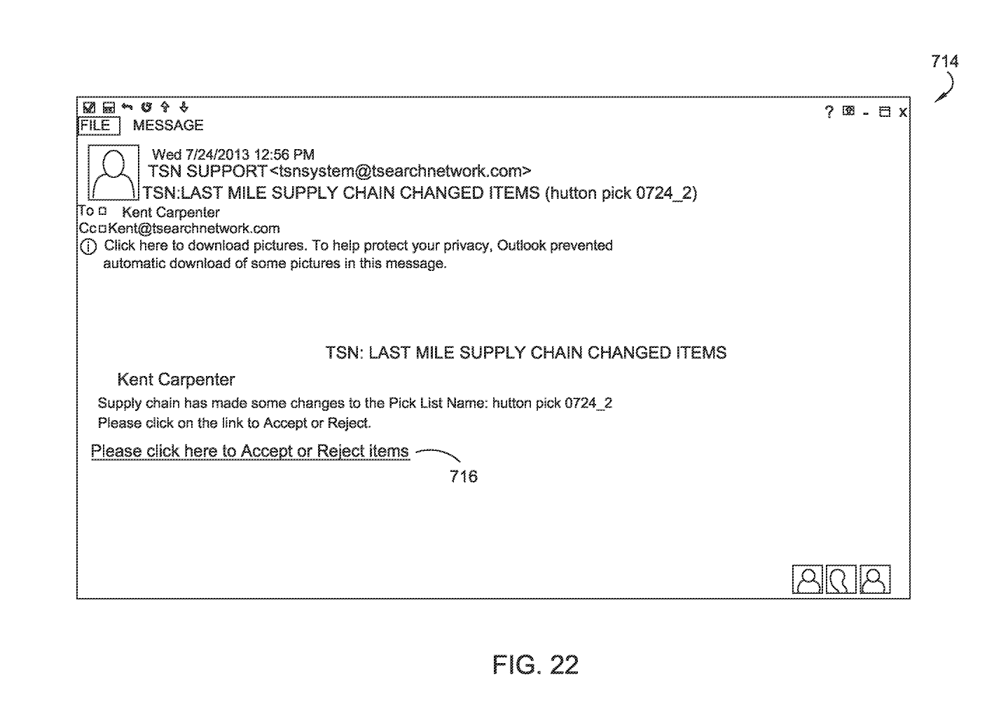

FIG. 21 presents another screenshot 712 displayable upon manipulation of the link 710 that allows the supply chain manager 128 to confirm the material callout, modify one or more details or parameters regarding the same (e.g., pickup time and/or date, asset quantities due to unavailability of all in the material callout request from the project manager 120, etc.), and then send a corresponding response back to the server 200 (e.g., via the portal 220). Upon receipt of the corresponding response at the server 200, the triggering engine 234 may trigger the alert/message generator 244 to generate and send a material callout acceptance or approval request 344 to the project manager 120. For instance, FIG. 22 presents a screenshot 714 of such a material callout acceptance that has a button or link 716 that allows the project manager 120 or other appropriate party to accept or reject 612 the material callout parameters as confirmed or adjusted by the supply chain manager 128 or the like.

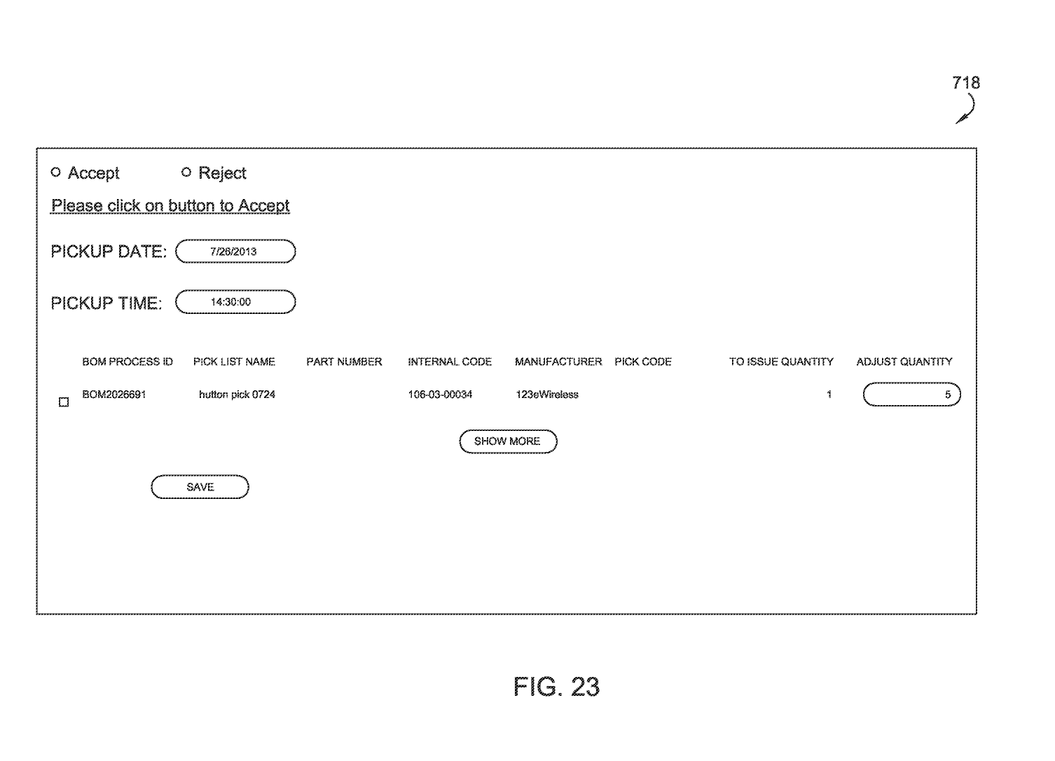

While not shown, the screenshot 714 may also include an attachment including the list of materials being called out. In any case, FIG. 23 presents another screenshot 718 displayable upon manipulation of the link 716 that allows the project manager 120 to accept or request the material callout; acceptance sends a signal to the triggering module 234 to send a corresponding material callout 316 to the warehouse 124, send a material pickup notification 320 to the shipper, etc. (e.g., steps 420-444 of FIG. 3). While also not shown, the triggering module may trigger one or more of the timing modules 224 to monitor for receipt confirmation of the material callout alert from the supply chain manager, data 227 and metrics 228 may be appropriately collected and manipulated by the analysis engine 232 and stored for presentation to users via dashboard 220 of portal 216.

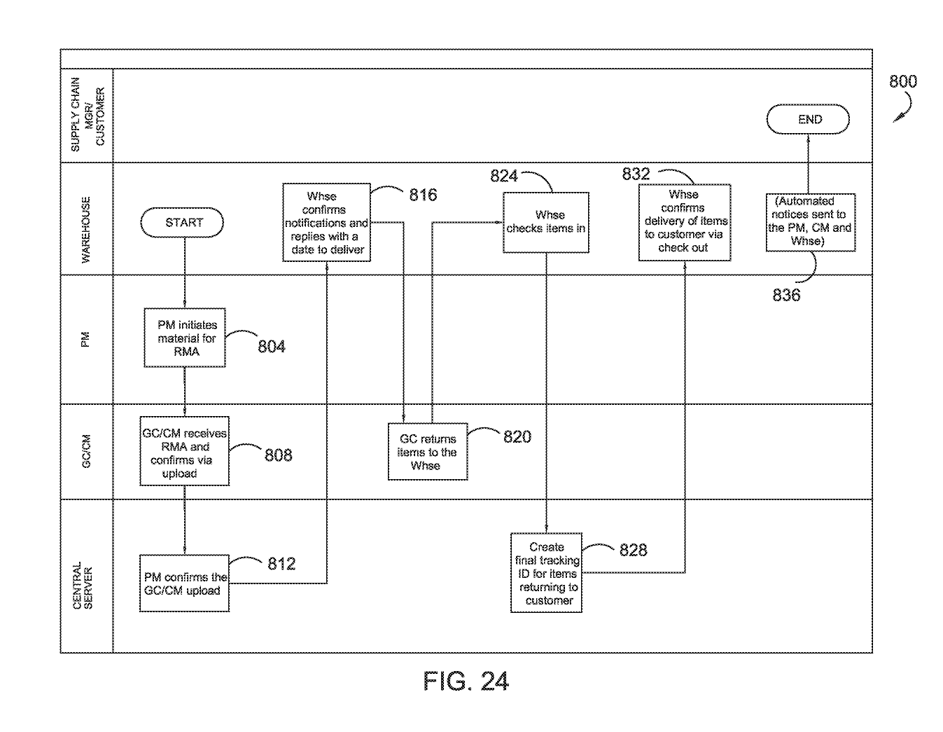

Reference is now made to FIG. 24 which presents a swim lane diagram of a method 800 of tracking and monitoring materials returned to the warehouse 124 or other location of the organization 108 from a job site (or from a shipper's possession) in response to a return material authorization (RMA) 334 (see FIG. 2) initiated by the project manager 120 or other appropriate party (e.g., to return assets delivered for incorporation at a job site but never used, to return improperly delivered assets, to return assets in the shipper's possession but not yet delivered to the job site after expiration of a corresponding timer, etc.). At step 804, a project manager 120 may access the portal 216 of the server 200 in any appropriate manner to initiate an RMA process for particular assets associated with a project.

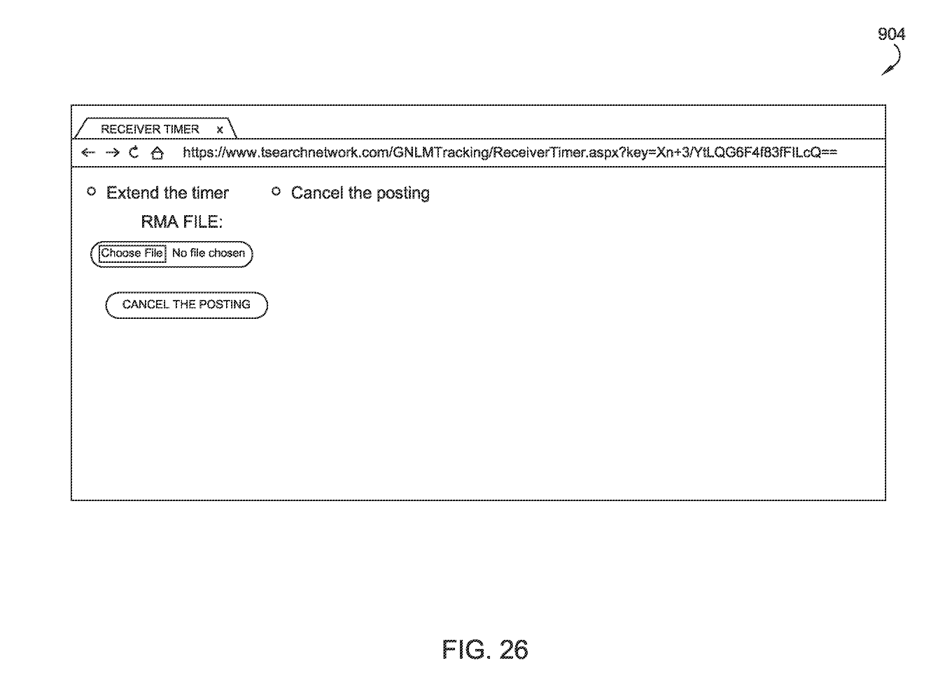

As just one example, FIG. 25 presents a screenshot 900 of an expired timer alert 310 (see FIG. 2) generated by the alert/message generator 244 and sent to a project manager 120 in response to expiration of a timer 240 of one of the timer modules 224 (i.e., the timer 240 reaching the end of its particular time period, e.g., 8 hours, 24 hours, etc., without its corresponding event having taken place). Manipulation of a button or link 902 directs the project manager 120 or other recipient to the screenshot 904 of FIG. 26 (e.g., a web-page or the like) that allows the project manager 120 communicate with the portal 216 to either extend the expired timer 240 of the corresponding timer module 224 or cancel the posting (e.g., the particular list of assets associated with the expired timer 240, such as the list of assets in the attachment 558 of FIG. 14 in the event timer 442 of FIG. 3 expires). In the event the project manager 120 or the like chooses to cancel the particular posting, a list of the particular assets (e.g., similar to the attachment 558 of FIG. 14) may be appropriately uploaded to the portal 216 via the screenshot 904 of FIG. 26 thus serving as an RMA 334 (see FIG. 2) from the project manager 120 to the server 200 and triggering a corresponding RMA process.

As an example, receipt of the uploaded list of assets to be returned at the portal 216 may send a signal to the triggering engine 234 to trigger the alert/message generator 244 to automatically generate and send 808 a corresponding RMA notification 336 (see FIG. 2) to the party responsible for the particular assets (e.g., the GC/CM 112 in the case where the warehouse 124 has issued the assets to the GC/CM 112 but the GC/CM 112 has failed to check the assets into the job site by the expiration of the timer 240 of fifth timer module 224₅ (e.g., timer 442 of FIG. 3)). For instance, the RMA notification 336 may be similar to the screenshot 556 of FIG. 14 whereby the GC/CM 112 may download an attachment 558 with a list of the assets to be returned, make any necessary modifications, and then manipulate link 560 to upload the list of assets to be returned thus serving as an RMA confirmation 338 (see FIG. 2) from the GC/CM 112 to the server 200.

With reference to FIG. 24, the method 800 may also include the project manager 120 confirming 812 the uploaded list of assets to be returned from the GC/CM 120 (e.g., in response to a confirmation request communication being generated and sent by the alert/message generator 244 to the project manager 120), the warehouse 120 confirming 816 a corresponding RMA notification 340 (e.g., in response to the corresponding RMA notification 340 being generated and sent by the alert/message generator 244 to the warehouse 124, where the RMA notification 340 may be similar to the screenshot 500 of FIG. 4), the GC/CM 112 returning 820 the corresponding assets to the warehouse 124, and the warehouse 124 checking in 824 the items (e.g., and confirming the same to server 200), such as via downloading the attachment 502 including the list of assets to be returned, manipulating link 504 of screenshot 504 of FIG. 4, and then uploading the list 348 of the returned assets to the central server 200).

In the event the assets being returned are those of the customer 116, the method 800 may further include the server 200 creating 828 a tracking ID for the assets, the warehouse 124 confirming 832 delivery of the assets to the customer 116 via check out (e.g., similar to issuing 436 step of FIG. 3), and then the server 200 automatically generating and sending corresponding delivery notices to the project manager 120, the warehouse 124, the GC/CM 112, and/or the customer 116. While not shown, the analysis engine 232 of the central server 200 may collect and/or generate data 227 and metrics 228 in association with one or more of the various steps of the method 800 of FIG. 24 for presentation to users via dashboard 220 of portal 216. In one arrangement, one or more timer modules 224 may be associated with one or more of the steps 800 in a manner as discussed previously to generate corresponding expired timer signals when one or more of the steps fail to occur within the timer period of the corresponding timer 240, trigger the alert/generator 244 to generate alerts based on the same, collect and generate corresponding data 227 and metrics 228, and the like.

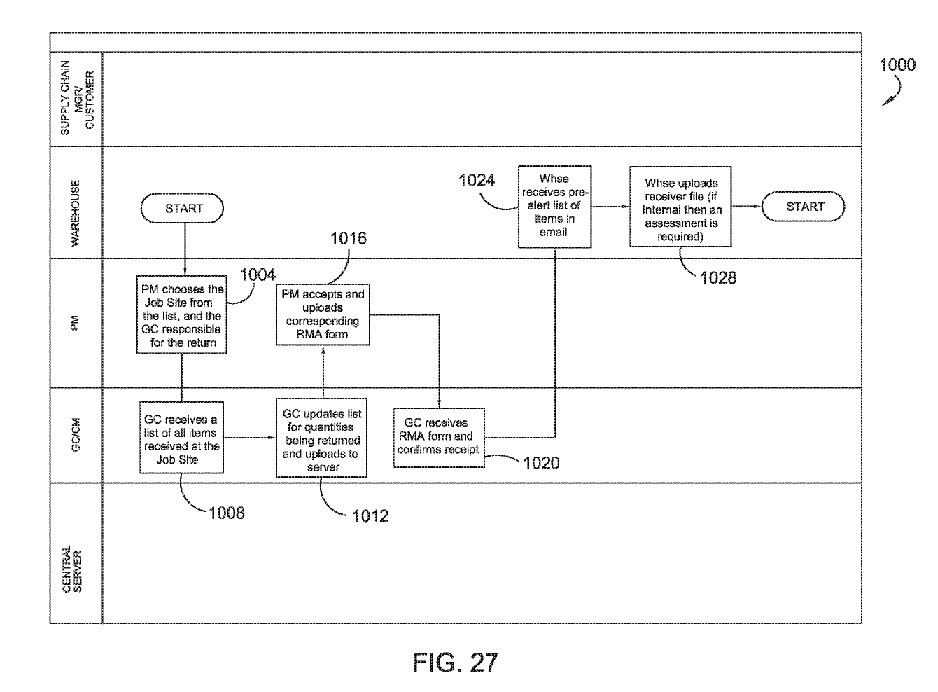

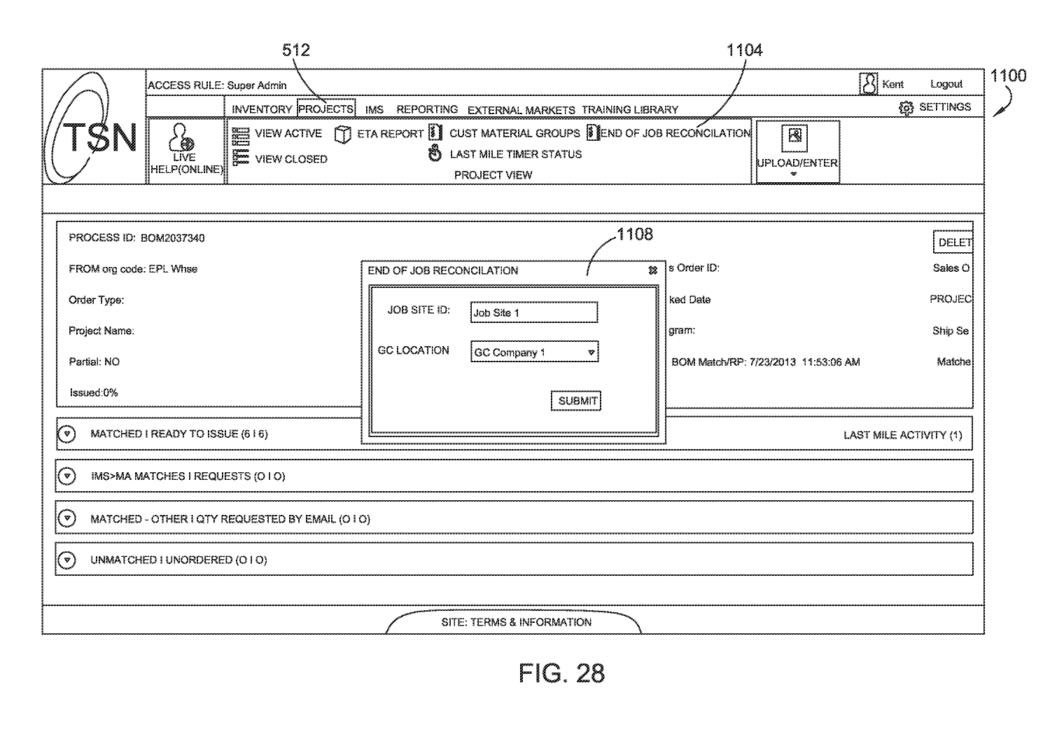

Reference is now made to FIG. 27 which presents a swim lane diagram of a method 1000 of tracking and monitoring materials returned to the warehouse 124 or other location of the organization 108 from a job site in response to an end of job (EOJ) reconciliation or closeout request. At step 1004, the project manager 120 (or other administrator) of the organization 108 may initiate an EOJ closeout request 342 (see FIG. 2) by way of accessing the portal 216 and selecting a particular job site and a GC/CM 120 (or other entity) responsible for the return. As an example, FIG. 28 presents a screenshot 1100 of the portal 216 (e.g., somewhat similar to screenshot 510 of FIG. 7) that may be presented on a display of computing device (e.g., tablet, laptop, etc.) of the project manager 120 upon accessing the portal 216 through any appropriate browser or the like on the computing device. For instance, upon manipulating the “Projects” tab 512 (e.g., which may then require selecting the appropriate project or process ID associated with the particular project of interest), an “End of Job Reconciliation” or the like button 1104 may be manipulated bringing up a window 1108 that allows a particular job site of the project and GC/CM 112 responsible for returning unused assets to be selected and submitted to the server 200.

At step 1008, the GC/CM 112 (or other responsible party) may receive a list of all items received at the job site. As an example, submission of the EOJ closeout request 342 to the portal 216 signals the triggering engine 234 (see FIG. 2) to trigger the alert/message generator 244 to generate and send a message (e.g., email, text) to the GC/CM 112 that has an attachment including a list of all of the assets initially received at the job site (e.g., before being incorporated into the job site). For instance, the message may be similar to the screenshot 556 of FIG. 14, where the attachment 558 reflects the assets actually received at the job site (e.g., possibly after any variances have been reconciled by the project manager 120).

The method 1000 then includes the GC/CM 112 updating 1012 the list of assets to reflect the assets being returned to the organization 108 (or customer 116) and uploading the same to the server 200 (e.g., where the assets being returned is a subset of the assets originally delivered to the job site). For instance, the GC/CM 112 may download the attachment 558 onto a computing device, make any necessary changes (e.g., to asset quantities, etc.) to reflect remaining assets (e.g., after having appropriately inventoried the remaining assets at the job site), and upload the revised list to the server 200 (e.g., via screenshot 562 of FIG. 15 or the like). In response to receipt of the uploaded list of materials, the portal 216 may signal the triggering engine 234 to trigger the alert/message generator 244 to generate and send a message (e.g., email, text) to the project manager 120 that has an attachment including the list of assets uploaded by the GC/CM 112. As an example, the message may be similar to the screenshot 714 of FIG. 22 but including an attachment with the list of assets uploaded by the GC/CM 112.

In one arrangement, the project manager 120 may download the attached list of assets to be returned, use the list of assets to be returned to create a corresponding RMA form, and upload the corresponding RMA form to the server 200 (e.g., via a screenshot similar to screenshot 904 of FIG. 26, although it would not be in the context of extending a timer or canceling a posting as is FIG. 26) which serves as the project manager 120 accepting 1016 the list of assets to be returned and uploading a corresponding RMA 334 (e.g., RMA form). At step 1020, the method 1000 may then include the GC/CM 112 receiving the RMA form uploaded by the project manager 120 and confirming receipt of the same. For instance, upload of the RMA 334 to the portal 216 may signal the triggering engine 234 (see FIG. 2) to trigger the alert/message generator 244 to generate and send a message (e.g., email, text) to the GC/CM 112 that has an attachment including the RMA 334 and that requests receipt of the same from the GC/CM 112 (e.g., where the message may be similar to the screenshot 534 of FIG. 10).

Upon the GC/CM 112 confirming 1020 receipt of the RMA form, the method 1000 may include the warehouse 120 (or other receiving location to which the assets are to be returned) receiving a “pre-alert” message (e.g., email, etc.) having an attachment that includes a list of the assets to be returned (e.g., where the message may be similar to the screenshot 556 of FIG. 14). Upon return of the assets to the warehouse 120 by the GC/CM 112, the warehouse 120 may appropriately modify (if necessary) the attached list of assets to reflect the assets actually returned and then upload the list to the server 200 (e.g., via the portal 216 as discussed herein). In one arrangement, the server 200 may create tracking IDs for assets being returned (e.g., as in step 440 of FIG. 3). While not shown, the analysis engine 232 of the central server 200 may collect and/or generate data 227 and metrics 228 in association with one or more of the various steps of the method 1000 of FIG. 27 for presentation to users via dashboard 220 of portal 216. In one arrangement, one or more timer modules 224 may be associated with one or more of the steps 800 in a manner as discussed previously to generate corresponding expired timer signals when one or more of the steps fail to occur within the timer period of the corresponding timer 240, trigger the alert/generator 244 to generate alerts based on the same, collect and generate corresponding data 227 and metrics 228, and the like.

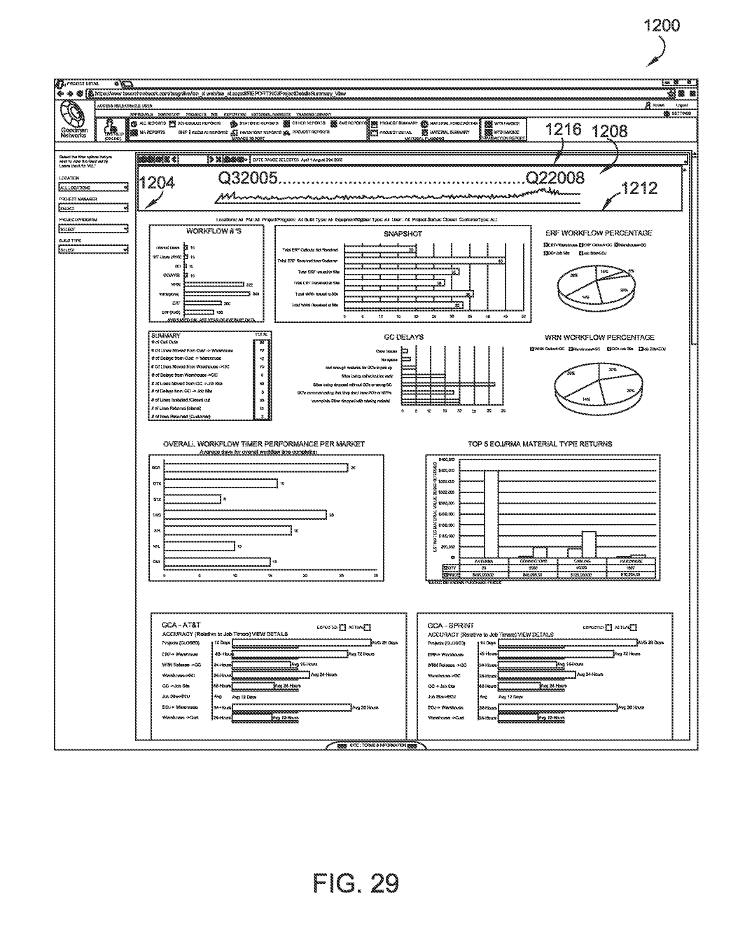

FIG. 29 presents a screenshot 1200 of the reporting dashboard 220 of portal 216 of FIG. 2 that is configured to display a number of various data and metrics (e.g., as collected and/or determined by analysis engine 232 of FIG. 2) regarding the movement of assets to a job site during the “last mile” (e.g., in relation to the method 400 of FIG. 3 or the like) in one or more appropriate formats (e.g., graphics, pie charts, etc.). As shown, the screenshot 1200 may include one or more user-manipulable parameter filtering features 1204 (e.g., drop-down menus, buttons, etc.) that allow a user to limit displayed metrics 1212 to particular filtering parameters (e.g., warehouse location, project manager name, project, customer type, etc.). The screenshot 1200 may also include one or more user-manipulable date filtering features 1208 that allow the user to limit the displayed metrics 1212 to one or more particular date ranges. In one arrangement, and as shown in FIG. 29, the date filtering features 1208 may include a “call-out” pulse 1216 of the total number of material callouts (e.g., step 404 of FIG. 3 and/or step 604 of FIG. 18) for the selected date range and filtering parameters. In response to a user selecting particular ones of the parameter filtering features 1204 and/or date filtering features 1208, the portal 216 signals the analysis engine 232 regarding the same triggering the analysis engine 232 to automatically predetermine the various metrics 1212 (e.g., and the “call-out” pulse 1216) presented in FIG. 29 as to the selected parameters and dates and then send the same back to the dashboard 220 for presentation to the user.

It will be readily appreciated that many additions and/or deviations may be made from the specific embodiments disclosed in the specification without departing from the spirit and scope of the invention. As an example, the various uses of “first,” “second,” etc. herein (e.g., first timer module 224₁, second timer module 224₂, etc.) is merely used to facilitate the reader's understanding of the various features and functionalities disclosed herein and that some of the timer modules 224 disclosed herein could be referred to by other names than those used herein. Furthermore, it is to be understood that users can dynamically add and remove timer modules from various processes disclosed herein based on any desired preferences.

Embodiments disclosed herein can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a non-volatile memory device, a composition of matter affecting a machine-readable propagated signal, or a combination of one or more of them. In this regard, the utilities may encompass one or more apparatuses, devices, and machines for processing data, including by way of example a programmable processor, a computer, or multiple processors or computers. In addition to hardware, the utilities may include code that creates an execution environment for the computer program in question, e.g., code that constitutes processor firmware, a protocol stack, a database management system, an operating system, or a combination of one or more of them.

A computer program (also known as a program, software, software application, script, or code) used to provide any of the functionalities described herein (e.g., construction of the first and second hierarchical data structures and the like) can be written in any appropriate form of programming language including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit). Processors suitable for the execution of a computer program may include, by way of example, both general and special purpose microprocessors, and any one or more processors of any kind of digital computer. Generally, a processor will receive instructions and data from a read-only memory or a random access memory or both. Generally, the elements of a computer are one or more processors for performing instructions and one or more memory devices for storing instructions and data. The techniques described herein may be implemented by a computer system configured to provide the functionality described.

While this specification contains many specifics, these should not be construed as limitations on the scope of the disclosure or of what may be claimed, but rather as descriptions of features specific to particular embodiments of the disclosure. Furthermore, certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

The above described embodiments including the preferred embodiment and the best mode of the invention known to the inventor at the time of filing are given by illustrative examples only.

1. A method for use in monitoring movement of assets towards at least one job site of a project, comprising:
generating, by a processor of a central server, a message that assets of a project are to be picked up from a location of an organization by a shipper;
sending the generated message to the shipper;
initiating, in conjunction with the sending, a first timer of a first timing module of the central server that sets forth a first period of time within which the shipper is to acknowledge receipt of the generated message;
collecting, by the central server, metrics related to acknowledgement of the message by the shipper; and
storing the collected metrics in a database of the central server.

2. The method of claim 1, further including before the generating by the first timing module:
receiving, at the central server, a message that assets of the project are to be picked up from a location of a customer by the organization;
generating, by the processor of the central server, an alert that the assets of the project are to be picked up from a location of the customer by the organization;
sending the alert to the organization;
initiating, in conjunction with the sending, a second timer of a second timing module of the central server that sets forth a second period of time within which the assets are to be picked up by the organization from the location of the customer;
collecting, by the central server, metrics related to picking up of the assets by the organization from the location of the customer; and
storing the collected metrics in the database of the central server.

3. The method of claim 2, further including:
receiving, at the central server, confirmation that the assets of the project were picked up from the location of the organization by the shipper;
initiating, in conjunction with the receiving, a third timer of a third timing module of the central server that sets forth a third period of time within which the assets are to be received at at least one job site of the project;
collecting, by the central server, metrics related to receipt of the assets at the at least one job site; and
storing the collected metrics in the database of the central server.

4. The method of claim 1, further including:
receiving, at the central server, confirmation that the assets of the project were picked up from the location of the organization by the shipper;
initiating, in conjunction with the receiving, a second timer of a second timing module of the central server that sets forth a second period of time within which the assets are to be received at least one job site of the project; and
collecting, by the central server, metrics related to receipt of the assets at the at least one job site; and
storing the collected metrics in the database of the central server.

5. The method of claim 4, further including:
generating a list of the assets to be received at the at least one job site;
comparing, by the processor of the central server, the generated list of assets to assets received at the at least one job site;
generating, by the processor of the central server, a list of variances between the generated list of assets and the assets received at the at least one job site; and
sending the list of variances to an administrator of the organization for reconciliation.

6. The method of claim 4, further including:
receiving, at the central server, a message that a subset of the assets are to be returned from the at least one job site to at least one of a location of the organization or a location of a customer of the organization;
sending, in response to the received message, a first communication to a party regarding the asset subset to be returned; and
initiating, in conjunction with the sending of the first communication, a third timer of a third timing module of the central server that sets forth a third period of time within which the party is to acknowledge the sent communication.

7. The method of claim 6, further including:
receiving, at the central server, an acknowledgment from the party regarding the sent communication;
sending, from the central server in response to the received acknowledgment, a list of the asset subset to the at least one of the location of the organization or the location of the customer of the organization;
sending, from the central server in response to the received acknowledgment, a second communication to the party to return the asset subset to the at least one of the location of the organization or the location of the customer of the organization; and
initiating, in conjunction with the sending of the second communication, a fourth timer of a fourth timing module of the central server that sets forth a fourth period of time within which the party is to return the asset subset to the at least one of the location of the organization or the location of the customer of the organization.

8. The method of claim 1, wherein the collected metrics include at least one of a length of time it took the shipper to pick up the assets from the location of the organization, whether the shipper picked up the assets within the first period of time, or one or more reasons why the assets were not picked up from the location of the organization by the shipper within the first period of time.

9. The method of claim 1, wherein the shipper is the organization or a general contractor.

10. The method of claim 1, further including:
presenting graphics related to the collected metrics on a display in communication with the central server.

11. (canceled)

12. A method for use in monitoring movement of assets towards at least one job site of a project, comprising:
receiving, at a processor of a central server, a signal that a shipper has assumed responsibility of assets at a location of an organization that is carrying out a project for a customer using the assets;
initiating, in response to the receiving, a first timer of a first timing module of the central server that sets forth a first period of time within which the assets are to be delivered to at least one job site of the project by the shipper, wherein the first timer is initiated at a first time;
obtaining metrics related to delivery of the assets to the at least one job site of the project by the shipper; and
storing the obtained metrics in the database of the central server.

13. The method of claim 12, further including:
receiving, at the processor of the central server, a signal that the assets have been received at the at least one job site at a second time, wherein the obtaining includes generating the metrics based on the second time.

14. The method of claim 13, further including:
determining, by the processor of the central server, whether the second time occurred within the first time period, wherein the generated metrics include the determination.

15. The method of claim 13, further including:
determining, by the processor of the central server, a difference between the first and second times, wherein the generated metrics include the determined difference.

16. The method of claim 13, wherein the receiving the signal that the assets have been received at the at least one job site includes receiving a list of the assets received at the at least one job site, and wherein the method further includes:
comparing, by the processor of the central server, the list of assets received at the at least one job site to a list of the assets for which the shipper assumed responsibility;
creating, by the processor of the central server, a list of variances between the list of assets received at the at least one job site and the list of the assets for which the shipper assumed responsibility; and
generating an alert based on the list of variances.

17. (canceled)

18. A method for use in monitoring movement of assets to at least one job site of a project, comprising:
receiving, at a central server, a message that assets of a project are to be picked up from a location of a customer by an organization for delivery to at least one job site of a project;
initiating, by a processor of the central server in conjunction with the receiving, a timer of a timing module that sets forth a period of time within which the assets are to be delivered to the at least one job site of the project;
generating, by the processor in conjunction with the initiating, an alert that the assets of the project are to be picked up from the location of the customer by the organization;
sending, by the processor, the alert to the organization;
obtaining metrics related to picking up of the assets by the organization from the location of the customer; and
storing the obtained metrics in a database of the central server.

19. The method of claim 18, wherein the timing module is a first timing module, and wherein the initiating further includes:
initiating, by the processor in conjunction with the generating, a timer of a second timing module that sets forth a period of time within which the assets are to be picked up by the organization from the location of the customer and received at a location of the organization, wherein the timer of the second timing module is configured to expire before the timer of the first timing module is configured to expire.

20. The method of claim 19, further including:
obtaining metrics related to the timer of at least one of the first and second timer modules; and
storing the obtained metrics in the database of the server.

21. The method of claim 19, further including:
receiving, at the processor of the central server, a signal that the assets have been received at the location of the organization;
generating, by the processor in response to the receiving, a message that the assets are to be picked up from the location of the organization by a shipper;
sending the generated message to the shipper;
initiating, in conjunction with the generating, a timer of a third timing module of the central server that sets forth a period of time within which the shipper is to acknowledge receipt of the generated message;
collecting, by the central server, metrics related to acknowledgement of the message by the shipper; and
storing the collected metrics in the database of the central server.

22. The method of claim 21, wherein the timer of the third timing module is configured to expire before the timer of the first timing module is configured to expire.

23. The method of claim 21, further including:
receiving, at the processor of a central server, a signal that a shipper has assumed responsibility of assets at the location of the organization;
initiating, in response to the receiving, a timer of a fourth timing module of the central server that sets forth a period of time within which the assets are to be delivered to at least one job site of the project by the shipper;
obtaining metrics related to delivery of the assets to the at least one job site of the project by the shipper; and
storing the obtained metrics in the database of the central server.

24. (canceled)

25. (canceled)
